(19) United States
(12) Patent Application Publication
(10) Pub. No.: US 2006/0232507 A1
(43) Pub. Date: Oct. 19, 2006

(54) Plasma display apparatus and method of driving the same

(76) Inventors: Dae Jin Myoung, Goyang-si (KR); Seong Hak Moon, Seoul (KR)

Correspondence Address: MCKENNA LONG & ALDRIDGE LLP;Song K. Jung, 1900 K Street, N.W., Washington, DC, 20006, US

(21) Appl. No.: 11/324,515

(22) Filed: Jan. 4, 2006

(30) Foreign Application Priority Data
Apr. 15, 2005 (KR) 10-2005-0031663
Apr. 15, 2005 (KR) 10-2005-0031659

(51) Int. Cl. G09G 3/28

(52) U.S. Cl. 345/60

(57) ABSTRACT

A plasma display apparatus and a method of driving the same, more particularly to, a plasma display apparatus considering the gray level values of sub-fields and a method of driving the same are provided. The plasma display apparatus controls the magnitudes of reset pulses or the widths of scan pulses in units of sub-fields thereby improving contrast, preventing driving margins from deteriorating, stabilizing discharges and improving. brightness.

This nonprovisional application claims priority under 35 U.S.C. §119(a) on patent application Nos. 10-2005-031663, 10-2005-031659 filed in Republic of Korea on Apr. 15, 2005, the entire contents of which are hereby incorporated by reference.

### BACKGROUND OF THE INVENTION

1. Field of the Invention

This document relates to a plasma display apparatus and a method of driving the same.

2. Description of the Background Art

In general, a plasma display apparatus comprises a plasma display panel (PDP) in which a barrier rib formed between a top surface substrate and a bottom surface substrate forms a unit cell. A main discharge gas such as Ne, He, and Ne+He and an inert gas comprising a small amount of xenon are filled in each cell. When a discharge is generated by a high frequency voltage, the inert gas generates vacuum ultraviolet (UV) rays and emits light from a phosphor formed between the barrier ribs to realize an image.

FIG. 1 illustrates the structure of a common PDP.

As illustrated in FIG. 1, according to the PDP, a top surface substrate 100 obtained by arranging a plurality of pairs of electrodes formed of scan electrodes 102 and sustain electrodes 103 that make pairs on a top surface glass 101 that is a display surface on which images are displayed and a bottom surface substrate 110 obtained by arranging a plurality of address electrodes 113 on a bottom surface glass 111 that forms the back surface to intersect the plurality of pairs of sustain electrodes are combined with each other to run parallel to each other by a uniform distance.

The top surface substrate 100 comprises the scan electrodes 102 and the sustain electrodes 103 for discharging each other in one discharge cell to sustain emission of the cell, that is, the scan electrodes 102 and the sustain electrodes 103 that comprise transparent electrodes a formed of transparent indium tin oxide (ITO) and bus electrodes b formed of metal and that make pairs. The scan electrodes 102 and the sustain electrodes 103 are covered with one or more dielectric layers 104 for restricting the discharge current of the scan electrodes 102 and the sustain electrodes 103 to insulate the pairs of electrodes from each other. A protective layer 105 on which MgO is deposited is formed on the entire surface of the dielectric layer 104 to facilitate discharge.

Stripe type (or well type) barrier ribs 112 for forming a plurality of discharge spaces, that is, discharge cells are arranged on the bottom surface substrate 110 to run parallel to each other. Also, the plurality of address electrodes 113 that perform address discharge to generate the vacuum UV rays are arranged to run parallel with respect to the barrier ribs 112. The bottom surface substrate 110 is coated with the R, G and B phosphors 114 that emit visible rays to display images during the address discharge. A lower dielectric layer 115 for protecting the address electrodes 113 is formed between the address electrodes 113 and the phosphors 114.

FIG. 2 illustrates the structure in which the electrodes are arranged in the conventional PDP.

As illustrated in FIG. 2, in the conventional plasma display panel 200, the scan electrodes Y1 to Yn and the sustain electrodes Z1 to Zn are arranged to run parallel to each other and the address electrodes X1 to Xm are formed to intersect the scan electrodes Y1 to Yn and the sustain electrodes Z1 to Zn.

A predetermined driving signal is applied to each of the electrodes of the PDP 200 arranged as described above to realize an image.

A method of realizing gray levels of the conventional PDP of the above structure will be described with reference to FIG. 3.

FIG. 3 illustrates a method of realizing gray levels of a conventional PDP.

As illustrated in FIG. 3, according to the method of realizing the gray levels of the conventional PDP, one frame period is divided into a plurality of sub-fields having a different number of light-emission times and each sub-field is divided into a reset period RPD for initializing all of the cells, an address period APD for selecting a cell to be discharged, and a sustain period SPD for realizing gray levels in accordance with the number of discharge times. For example, when an image is to be displayed by 256 gray levels, a frame period (16.67 ms) corresponding to 1/60 second is divided into eight sub-fields SF1 to SF8 as illustrated in FIG. 2 and each of the eight sub-fields SF1 to SF8 is divided into the reset period, the address period, and the sustain period.

The reset period and the address period are the same in each of the sub-fields. The address discharge for selecting the cell to be discharged is generated by difference in voltage between the address electrodes and the transparent electrodes that are the scan electrodes. The sustain period in each sub-field increases in the ratio of 2n (n=0. 1. 2. 3. 4. 5. 6, and 7). As described above, since the sustain period varies with each sub-field, it is possible to realize gray levels of an image by controlling the sustain period of each sub-field, that is, the number of times a sustain discharge occurs. Driving waveforms in accordance with such a method of driving the PDP will be described with reference to FIG. 4.

FIG. 4 illustrates driving waveforms in accordance with the method of driving the conventional PDP. As illustrated in FIG. 4, the PDP is driven such that each sub-field is divided into a reset period for initializing all of the cells, an address period for selecting a cell to be discharged, a sustain period for sustaining the discharge of the selected cell, and an erase period for erasing wall charges in the discharged cell.

In the set up period of the reset period, a rising ramp waveform Ramp-up is simultaneously applied to all of the scan electrodes. A dark discharge is generated in the discharge cells of the entire screen due to the rising ramp waveform. Positive wall charges are accumulated on the address electrodes and the sustain electrodes and negative wall charges are accumulated on the scan electrodes due to the set up discharge.

In the set down period of the reset period, after the rising ramp waveform is supplied, a falling ramp waveform Ramp-down that starts to fall from a positive voltage lower than the peak voltage of the rising ramp waveform and to thus falls to a specific voltage level no more than a ground GND level voltage generates a weak erase discharge in the cells to erase the wall charges excessively formed in the scan electrodes. Wall charges in an amount that can stably generate the address discharge uniformly reside in the cells due to the set down discharge.

In the address period, a negative scan pulse is sequentially applied to the scan electrodes and, at the same time, a positive data pulse is applied to the address electrodes in synchronization with the scan pulse. When the difference in voltage between the scan pulse and the data pulse is added to the wall voltage generated in the reset period, the address discharge is generated in the discharge cell to which the data pulse is applied. Wall charges in an amount that can generate a discharge when the sustain voltage Vs is applied are formed in the cells selected by the address discharge. A positive bias voltage Vz is supplied to the sustain electrodes in the set down period and the address period so that the difference in voltage between the scan electrodes and the sustain electrodes is reduced to prevent erroneous discharge from being generated between the scan electrodes and the sustain electrodes.

In the sustain period, sustain pulses sus are alternately applied to the scan electrodes and the sustain electrodes. In the cells selected by the address discharge, the wall voltage in the cells is added to the sustain pulse so that the sustain discharge, that is, display discharge is generated between the scan electrodes and the sustain electrodes whenever each sustain pulse is applied.

After the sustain discharge has completed, a voltage of an erase ramp waveform Ramp-ers having a small pulse width and a low voltage level is supplied to the sustain electrodes in the erase period to erase the wall charges that reside in the cells of the entire screen.

In the conventional driving waveforms, the magnitudes of the reset pulses of all of the sub-fields are the same.

The magnitude of the reset pulses in the conventional driving waveforms will be described with reference to FIG. 5.

FIG. 5 illustrates reset pulses in a driving waveform in accordance with the method of driving the conventional PDP of FIG. 4 in detail.

As illustrated in FIG. 5, in the driving waveform in accordance with the method of driving the conventional PDP, the magnitudes of the reset pulses of all of the sub-fields are the same.

For example, as illustrated in FIG. 5, in the conventional driving waveform, in the reset pulse applied to the scan electrodes in the reset period of each sub-field, the rising ramp rises from a predetermined positive voltage, for example, the sustain voltage Vs to a set up voltage Vsetup with a predetermined slope and then, falls to the predetermined positive voltage.

According to the method of driving the conventional PDP in which the reset pulses of the same magnitude are applied in all of the sub-fields, it is possible to sufficiently initialize the discharge cells of the PDP in the reset period so that a driving margin is relatively high. However, according to the conventional driving waveform, in the reset periods of all of the sub-fields, relatively strong discharge is generated due to the relatively high set up voltage Vsetup.

Therefore, the magnitude of the unnecessary discharge that does not contribute to display of an image increases, thereby causing a deterioration in contrast.

Unlike the above-described example, according to the conventional art, the reset pulses are not applied in the reset periods of all of the sub-fields of one frame as described above, and the reset pulses are applied only in one or more sub-field selected from one frame to improve the contrast characteristic. For example, sub-fields of a selective writing method and sub-fields of a selective erasing method are comprised in one frame to realize an image.

A method of driving a PDP in which the sub-fields of the selective writing method and the sub-fields of the selective erasing method are used will be described with reference to FIG. 6.

FIG. 6 illustrates a method of driving a PDP in which selective writing sub-fields and selective erasing sub-fields are comprised. As illustrated in FIG. 6, one frame comprises selective writing sub-fields WSF each comprising one or more sub-field and selective erasing sub-fields ESF each comprising one or more sub-field.

The selective writing sub-fields WSF comprise m (m is a positive integer larger than 0) sub-fields SF1 to SFm. Each of the first to m−1th sub-fields SF1 to SFm−1 excluding the mth sub-field SFm is divided into a reset period for uniformly forming positive wall charges in the cells of the entire screen, a selective writing address period (hereinafter, referred to as a writing address period) for selecting on-cells using writing discharge, a sustain period for generating sustain discharge in the selected on-cells, and an erasing period for erasing the wall charges in the cells after the sustain discharge.

The mth sub-field SFm that is the last sub-field of the selective writing sub-fields WSF is divided into the reset period, the writing address period, and the sustain period. The reset period, the writing address period, and the erasing period are the same in each of the sub-fields SF1 to SFm of the selective writing sub-fields WSF, a previously set brightness brightness weight value may be the same or vary in the sustain period.

The selective erasing sub-fields ESF comprise n-m (n is a positive integer larger than m) sub-fields SFm+1 to SFn. Each of the m+1th to nth sub-fields SFm+1 to SFn is divided into a selective erasing address period (hereinafter, referred to as an erasing address period) for selecting off-cells using an erasing discharge and a sustain period for generating sustain discharge in the on-cells. In each of the sub-fields SFm+1 to SFn of the selective erasing sub-fields ESF, the erasing address period is the same and the sustain period may be the same or vary in accordance with a brightness relative ratio.

According to the method of driving the PDP illustrated in FIG. 6, m sub-fields are driven by the selective writing method and the n-m sub-fields are driven by the selective erasing method so that it is possible to reduce the address period. That is, one frame comprises the selective erasing sub-fields having a short scan pulse so that it is possible to secure enough sustain period.

The reset pulse in each sub-field in accordance with the method of driving the PDP in which the selective writing sub-fields and the selective erasing sub-fields are comprised in one frame as illustrated in FIG. 6 will be described in detail with reference to FIG. 7.

FIG. 7 illustrates the magnitudes of the reset pulses applied to the scan electrodes in the reset periods in accordance with the method of driving the PDP of FIG. 6.

As illustrated in FIG. 7, according to the method of driving the PDP in which the selective writing sub-fields and the selective erasing sub-fields are comprised in one frame as illustrated in FIG. 6, the reset period is provided only in the selective writing sub-fields to apply the reset pulse.

For example, when it is assumed that the first sub-field is the selective writing sub-field and the remaining sub-fields, that is, the second to nth sub-fields are the selective erasing sub-fields, the reset pulse is applied only in the first sub-field that is the selective writing sub-field and the reset pulse is not applied in the other sub-fields. Therefore, the magnitude of the unnecessary discharge that does not contribute to display of an image decreases so that contrast improves.

However, according to such a driving method, it is difficult to sufficiently initialize the discharge cells of the PDP compared with the conventional driving method in which the reset pulse is applied in the reset periods of all of the sub-fields so that the driving margin is reduced.

The scan pulses applied to the scan electrodes in the address period in the driving waveforms of FIG. 4 will be described in detail with reference to FIG. 8.

FIG. 8 illustrates the scan pulses applied to the scan electrodes in the address period in the conventional driving waveforms in detail.

As illustrated in FIG. 8, in the conventional driving waveforms, the scan pulses are sequentially applied to the scan electrodes in the order where the scan electrodes Y1 to Yn are arranged. For example, as illustrated in FIG. 8, a scan pulse is first applied to the scan electrode Y1 that comes first on the PDP and then, another scan pulse is applied to the scan electrode Y2 that comes next to the scan electrode Y1.

The widths of the scan pulses applied to the scan electrodes Y1 to Yn are the same. The widths of the scan pulses will be described with reference to FIG. 9.

FIG. 9 illustrates the widths of the scan pulses applied to the scan electrodes in the address period in the conventional driving waveforms.

As illustrated in FIG. 9, in the driving waveforms in accordance with the method of driving the conventional PDP, the widths of the scan pulses applied to the scan electrodes Y1 to Yn are the same. For example, when it is assumed that the width of the scan pulse applied to the scan electrode Y1 is W as illustrated in FIG. 9, the width of the scan pulse applied to the scan electrode Y2 is also W and the width of the scan pulse applied to the scan electrode Yn is also W.

As described above, when the width of the scan pulse applied to the scan electrode Y1 that comes first on the PDP and the width of the scan pulse applied to the scan electrode Yn that comes last on the PDP are the same as illustrated in FIG. 2, the address discharge becomes unstable in the scan electrode Yn that comes last. The reason why the address discharge becomes unstable in the scan electrode Yn will be described as follows.

In the structure in which the electrodes are arranged as illustrated in FIG. 2, since the scan electrode Y1 is scanned first, the address discharge is generated by the scan electrode Y1 within a short time after the reset discharge generated in the reset period. Since the scan electrode Yn is scanned last, the address discharge is generated by the scan electrode Yn after a long time after the reset discharge generated in the reset period.

Immediately after the reset discharge, a plurality of priming particles generated by the reset discharge exist in the discharge cell. The number of priming particles is reduced in the discharge cell as time lapses. Therefore, in the case of the scan electrode Yn that is scanned last as described above so that the address discharge is generated after a long time after the reset discharge, the number of priming particles that exist in the discharge cell is small so that the address discharge becomes weak or, even worse, the address discharge is not generated. As a result, the address discharge becomes unstable when the scan electrode Yn is scanned last.

To solve the above problem, according to the conventional art, the width of all of the scan pulses is set to increase so that the address discharge stabilizes when the scan electrode is scanned later such as the above-described scan electrode Yn.

However, when the width of the scan pulses increases, the address period increases. Therefore, the sustain period that follows the address period decreases and thus, the number of sustain pulses decreases so that the brightness realized when the PDP is driven decreases.

In the driving waveforms in accordance with the method of driving the conventional PDP, the widths of the scan pulses in all of the sub-fields are the same. The driving waveforms will be described with reference to FIG. 10.

FIG. 10 illustrates the widths of the scan pulses applied to the scan electrodes in the sub-fields of one frame in the conventional driving waveform.

As illustrated in FIG. 10, in the driving waveform in accordance with the method of driving the conventional PDP, when it is assumed that one frame is composed of eight sub-fields, the widths of the scan pulses in all of the sub-fields, that is, the first to eighth sub-fields are the same, that is, W.

As illustrated in FIG. 10, when one frame is divided into a plurality of sub-fields, the brightness weight values of the sub-fields are different from each other so that the values of the realized gray levels are difference from each other. For example, one frame is divided into the sub-fields that have higher brightness weight values to realize higher gray levels and the sub-fields that have lower brightness weight values to realize lower gray levels.

When the sub-field that realizes the higher gray level, for example, the eighth sub-field of FIG. 10 has a higher brightness weight value, the eighth sub-field is frequently selected when the screen of the PDP is bright. When the first sub-field has a lower brightness weight value, the first sub-field is frequently selected when the screen of the PDP is dark. That is, when the screen is bright, the eighth sub-field that has a higher brightness weight value is frequently selected but the first sub-field is not likely to be selected.

Therefore, when the screen is bright, although the width of the scan pulse in the first sub-field that has a lower brightness weight value is small, all of the discharges of the PDP are maintained stable. However, according to the conventional art, since the widths of the scan pulses of all of the sub-fields are the same in one frame comprising the sub-fields that are selected with different frequencies in accordance with difference in the brightness of the screen, the address period increases so that the sustain period that follows the address period is reduced and that the number of sustain pulses is reduced. Therefore, the brightness of the PDP is reduced.

### SUMMARY OF THE INVENTION

Accordingly, an object of the present invention is to solve at least the problems and disadvantages of the background art.

It is an object of the present invention to provide a plasma display apparatus capable of controlling the magnitudes of the reset pulses applied to scan electrodes in the reset periods considering the gray level values of sub-fields to prevent a driving margin from deteriorating and to improve contrast characteristic and a method of driving the same.

It is another object of the present invention to provide a plasma display apparatus capable of controlling the widths of the scan pulses applied to the scan electrodes in the order of scanning to stabilize address discharge and a method of driving the same.

It is still another object of the present invention to provide a plasma display apparatus capable of controlling the widths of the scan pulses applied to the scan electrodes in accordance with an average picture level (APL) so that the address discharge is stably generated although an address period is reduced and a method of driving the same.

A plasma display apparatus according to the present invention comprises a plasma display panel comprising scan electrodes, a driver driving the electrodes, and a reset pulse controller controlling the driver to control the magnitudes of the reset pulses applied to the scan electrodes in the reset periods of at least one sub-field among the sub-fields of one frame in accordance with gray level values.

An apparatus for driving a plasma display panel according to the present invention comprises a driver driving the electrodes and a reset pulse controller controlling the driver to control the magnitudes of the reset pulses applied to the scan electrodes in the reset periods of at least one sub-fields among the sub-fields of one frame in accordance with gray level values.

A plasma display panel according to the present invention controls the magnitudes of the reset pulses applied to the scan electrodes in the reset periods of at least one sub-fields among the sub-fields of one frame in accordance with gray level values.

A plasma display apparatus according to the present invention comprises a plurality of scan electrodes and controller controlling the magnitudes of the reset pulses applied to the scan electrodes in the reset periods of at least one sub-fields among the sub-fields of one frame in accordance with gray level values.

In a plasma display apparatus according to the present invention, the driver controls the magnitudes of the reset pulses applied to the scan electrodes in the reset periods of at least one sub-fields among the sub-fields of one frame in accordance with gray level values.

In a method of driving a plasma display apparatus, the magnitudes of the reset pulses applied to the scan electrodes in the reset periods of at least one sub-fields among the sub-fields of one frame are controlled in accordance with gray level values.

A plasma display apparatus according to the present invention comprises a plasma display panel comprising scan electrodes, a driver driving the electrodes, and a reset pulse controller controlling the driver to set the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

An apparatus for driving a plasma display panel according to the present invention comprises a driver driving the electrodes and a reset pulse controller controlling the driver to set the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

In a plasma display panel according to the present invention, the magnitudes of the reset pulses applied to the scan electrodes in the reset periods of the low gray level sub-fields among the sub-fields of one frame are more than the magnitudes of the reset pulses applied to the scan electrodes in the reset periods of the remaining sub-fields.

A plasma display apparatus according to the present invention comprises a plurality of scan electrodes and controller setting the magnitudes of the reset pulses applied to the scan electrodes in the reset periods of the low gray level sub-fields among the sub-fields of one frame to be more than the magnitudes of the reset pulses applied to the scan electrodes in the reset periods of the remaining sub-fields.

The driver of a plasma display apparatus according to the present invention sets the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

In a method of driving a plasma display apparatus according to the present invention, the magnitudes of the reset pulses applied to the scan electrodes in the reset periods of low gray level sub-fields among the sub-fields of one frame are larger than the magnitudes of the reset pulses applied to the scan electrodes in the reset periods of the remaining sub-fields.

A plasma display apparatus according to the present invention comprises a plasma display panel comprising scan electrodes, a driver driving the electrodes, and a reset pulse controller controlling the driver to set the magnitudes of the reset pulses applied to the scan electrodes in the reset periods of the high gray level sub-fields among the sub-fields of one frame to be less than the magnitudes of the reset pulses applied to the scan electrodes in the reset periods of the remaining sub-fields.

An apparatus for driving a plasma display panel according to the present invention comprises a driver driving the electrodes and a reset pulse controller controlling the driver to set the magnitudes of the reset pulses applied to the scan electrodes in the reset periods of high gray level sub-fields among the sub-fields of one frame to be less than the magnitudes of the reset pulses applied to the scan electrodes in the reset periods of the remaining sub-fields.

In a plasma display panel according to the present invention, the magnitudes of the reset pulses applied to the scan electrodes in the reset periods of the high gray level sub-fields among the sub-fields of one frame are less than the magnitudes of the reset pulses applied to the scan electrodes in the reset periods of the remaining sub-fields.

A plasma display apparatus according to the present invention comprises a plurality of scan electrodes and controller setting the magnitudes of the reset pulses applied to the scan electrodes in the reset periods of high gray level sub-fields among the sub-fields of one frame to be less than the magnitudes of the reset pulses applied to the scan electrodes in the reset periods of the remaining sub-fields.

The driver of a plasma display apparatus according to the present invention sets the magnitudes of the reset pulses applied to the scan electrodes in the reset periods of high gray level sub-fields among the sub-fields of one frame to be less than the magnitudes of the reset pulses applied to the scan electrodes in the reset periods of the remaining sub-fields.

In a method of driving a plasma display apparatus according to the present invention, the magnitudes of the reset pulses applied to the scan electrodes in the reset periods of high gray level sub-fields among the sub-fields of one frame are less than the magnitudes of the reset pulses applied to the scan electrodes in the reset periods of the remaining sub-fields.

A plasma display apparatus according to the present invention comprises a plasma display panel comprising scan electrodes, a driver driving the scan electrodes, and a scan pulse controller controlling the driver to set the width of the scan pulses applied to one or more scan electrode group among a plurality of scan electrode groups comprising the one or more scan electrodes in one or more sub-fields of one frame in the order of scanning to be different from the width of the scan pulses applied to the remaining scan electrode groups.

An apparatus for driving a plasma display panel according to the present invention comprising a driver driving the scan electrodes and a scan pulse controller controlling the driver to set the width of the scan pulses applied to one or more scan electrode group among a plurality of scan electrode groups comprising the one or more scan electrodes in one or more sub-fields of one frame in the order of scanning to be different from the width of the scan pulses applied to the remaining scan electrode groups.

In a plasma display panel according to the present invention, the width of the scan pulses applied to one or more scan electrode group among a plurality of scan electrode groups comprising the one or more scan electrodes in one or more sub-fields of one frame in the order of scanning is different from the width of the scan pulses applied to the remaining scan electrode groups.

In a method of driving a plasma display apparatus according to the present invention, the width of the scan pulses applied to one or more scan electrode group among a plurality of scan electrode groups comprising the one or more scan electrodes in one or more sub-fields of one frame in the order of scanning is different from the width of the scan pulses applied to the remaining scan electrode groups.

A plasma display apparatus according to the present invention comprises a plasma display panel comprising scan electrodes, a driver driving the scan electrodes, and a scan pulse controller controlling the driver to control the widths of the scan electrodes applied to the scan electrodes in one or more sub-fields of one frame in accordance with an average picture level (APL).

An apparatus for driving a plasma display panel according to the present invention comprises a driver driving the scan electrodes and a scan pulse controller controlling the driver to control the widths of the scan pulses applied to the scan electrodes in one or more sub-field of one frame in accordance with an APL.

In a plasma display panel according to the present invention, the widths of the scan pulses applied to the scan electrodes are controlled in one or more sub-field of one frame in accordance with an APL.

In a method of driving a plasma display apparatus according to the present invention, the widths of the scan pulses applied to the scan electrodes are controlled in one or more sub-field of one frame in accordance with an APL.

According to the present invention, the magnitude of the reset pulses is larger in the low gray level sub-fields that realize the low gray levels and the magnitude of the reset pulses is smaller in the high gray level sub-fields that realize the high gray levels in one frame so that it is possible to improve the contrast characteristic and to prevent the driving margin from deteriorating.

According to the present invention, the widths of the scan pulses applied to the plurality of scan electrode groups each comprising one or more scan electrode are controlled in one sub-field in the order of scanning, the widths of the scan pulses in the high gray level sub-fields are increased when the APL is high, and the widths of the scan pulses in the low gray level sub-fields are increased when the APL is low so that it is possible to stabilize the entire discharge of the PDP and to reduce the address period. Therefore, the number of sustain pulses applied in the sustain period is increased so that it is possible to improve the brightness realized when the PDP is driven.

### BRIEF DESCRIPTION OF THE DRAWINGS

The present invention will be described in detail with reference to the following drawings in which like numerals refer to like elements.

FIG. 1 illustrates the structure of a conventional plasma display panel (PDP).

FIG. 2 illustrates the structure in which electrodes are arranged in the conventional PDP.

FIG. 3 illustrates a method of realizing gray levels of a conventional PDP.

FIG. 4 illustrates driving waveforms in accordance with the method of driving the conventional PDP.

FIG. 5 illustrates reset pulses in a driving waveform in accordance with the method of driving the conventional PDP of FIG. 4 in detail.

FIG. 6 illustrates a method of driving a PDP in which selective writing sub-fields and selective erasing sub-fields are comprised in one frame.

FIG. 7 illustrates the magnitudes of the reset pulses applied to the scan electrodes in the reset periods in accordance with the method of driving the PDP of FIG. 6.

FIG. 8 illustrates the scan pulses applied to the scan electrodes in an address period in the conventional driving waveforms in detail.

FIG. 9 illustrates the widths of the scan pulses applied to the scan electrodes in the address period in the conventional driving waveforms.

FIG. 10 illustrates the widths of the scan pulses applied to the scan electrodes in the sub-fields of one frame in the conventional driving waveform.

FIG. 11 illustrates a plasma display apparatus for applying the reset pulses according to the present invention.

FIGS. 12A and 12B illustrate a first embodiment of a method of driving the plasma display apparatus for applying the reset pulses according to the present invention.

FIG. 13 illustrates an example of a method of setting low gray level sub-fields according to the first embodiment of the method of driving the plasma display apparatus for applying the reset pulses according to the present invention.

FIG. 14 illustrates another driving waveform according to the first embodiment of the method of driving the plasma display apparatus for applying the reset pulses according to the present invention.

FIG. 15 illustrates the arrangement of the sub-fields in one frame according to the first embodiment of the method of driving the plasma display apparatus for applying the reset pulses according to the present invention.

FIGS. 16A and 16B illustrate a second embodiment of the method of driving the plasma display apparatus for applying the reset pulses according to the present invention.

FIG. 17 illustrates an example of a method of setting high gray level sub-fields according to the second embodiment of the method of driving the plasma display apparatus for applying the reset pulses according to the present invention.

FIG. 18 illustrates another driving waveform according to the second embodiment of the method of driving the plasma display apparatus for applying the reset pulses according to the present invention.

FIG. 19 illustrates the arrangement of the sub-fields in one frame according to the second embodiment of the method of driving the plasma display apparatus for applying the reset pulses according to the present invention.

FIGS. 20A and 20B illustrate a third embodiment of the method of driving the plasma display apparatus for applying the reset pulses according to the present invention.

FIG. 21 illustrates another driving waveform according to the third embodiment of the method of driving the plasma display apparatus for applying the reset pulses according to the present invention.

FIG. 22 illustrates an example of a method of setting low gray level sub-fields according to the third embodiment of the method of driving the plasma display apparatus for applying the reset pulses according to the present invention.

FIG. 23 illustrates an example of a method of setting high gray level sub-fields according to the third embodiment of the method of driving the plasma display apparatus for applying the reset pulses according to the present invention.

FIG. 24 illustrates the arrangement of the sub-fields in one frame according to the third embodiment of the method of driving the plasma display apparatus for applying the reset pulses according to the present invention.

FIG. 25 illustrates the structure of the plasma display apparatus for applying scan pulses according to the present invention.

FIG. 26 illustrates that the scan electrodes Y1 to Yn formed on the PDP are divided into four scan electrode groups to describe the method of driving the plasma display apparatus for applying the scan pulses according to the present invention.

FIG. 27 illustrates a fourth embodiment of the method of driving the plasma display apparatus for applying the scan pulses according to the present invention.

FIG. 28 illustrates the widths of the scan pulses controlled in the order of scanning in detail.

FIG. 29 illustrates an example of the difference in width between the scan pulses according to the fourth embodiment of the method of driving the plasma display apparatus for applying the scan pulses according to the present invention.

FIG. 30 illustrates another example of the difference in width between the scan pulses according to the fourth embodiment of the method of driving the plasma display apparatus for applying the scan pulses according to the present invention.

FIG. 31 illustrates an example of dividing the scan electrodes formed on the plasma display panel into scan electrode groups each comprising one or more scan electrodes so that the number of scan electrodes in each scan electrode group varies.

FIG. 32 illustrates an average picture level (APL).

FIG. 33 illustrates the fifth embodiment of the method of driving the plasma display apparatus for applying the scan pulses according to the present invention.

FIG. 34 illustrates an example of controlling the widths of the scan pulses in the plurality of sub-fields in one frame in accordance with the APL.

FIG. 35 illustrates another example of controlling the widths of the scan pulses in the plurality of sub-fields in one frame in accordance with the APL.

FIG. 36 illustrates the widths of the scan pulses in the remaining sub-fields excluding the low gray level sub-fields.

FIG. 37 illustrates an example of the difference in width between the scan pulses according to the fifth embodiment of the method of driving the plasma display apparatus for applying the scan pulses according to the present invention.

FIG. 38 illustrates another example of the difference in width between the scan pulses according to the fifth embodiment of the method of driving the plasma display apparatus for applying the scan pulses according to the present invention.

FIG. 39 illustrates an example of the case in which the APL is high according to the fifth embodiment of the method of driving the plasma display apparatus for applying the scan pulses according to the present invention.

FIG. 40 illustrates an example of controlling the widths of the scan pulses in the plurality of sub-fields in one frame in accordance with the APL.

FIG. 41 illustrates another example of controlling the widths of the scan pulses in the plurality of sub-fields in one frame in accordance with the APL.

FIG. 42 illustrates the widths of the scan pulses in the remaining sub-fields excluding high gray level sub-fields.

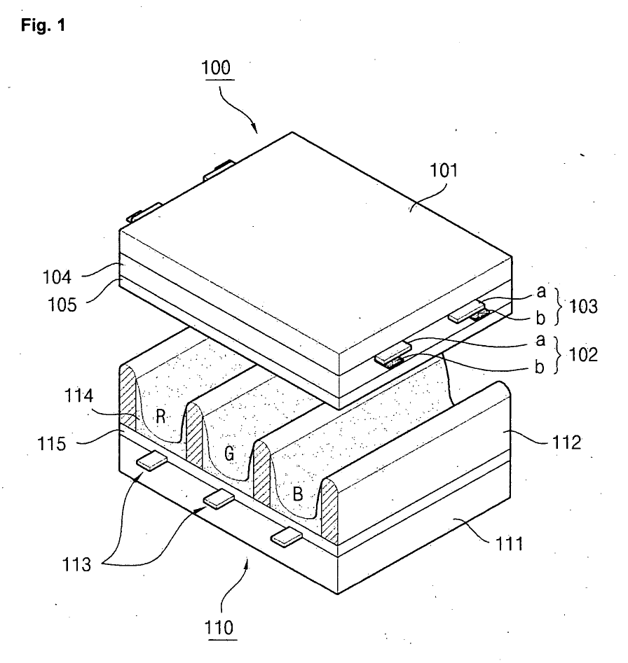

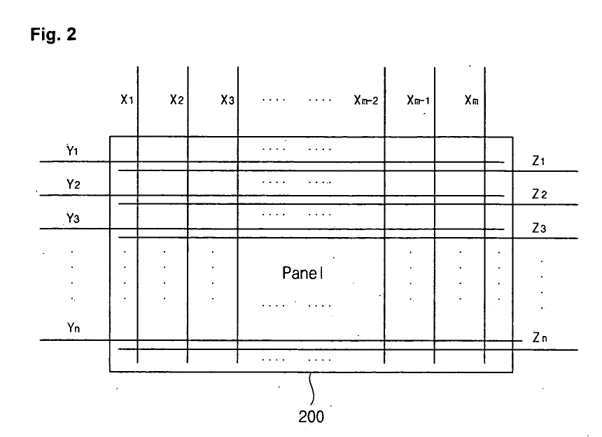

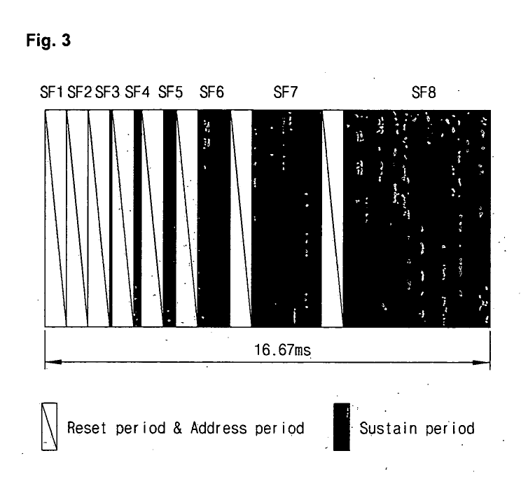

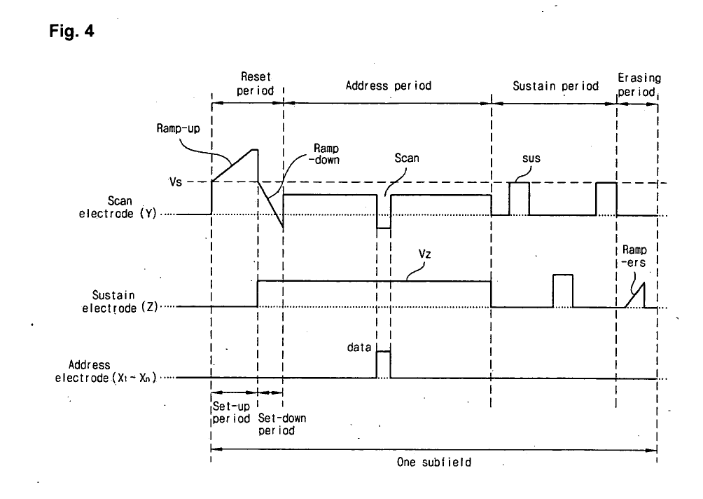

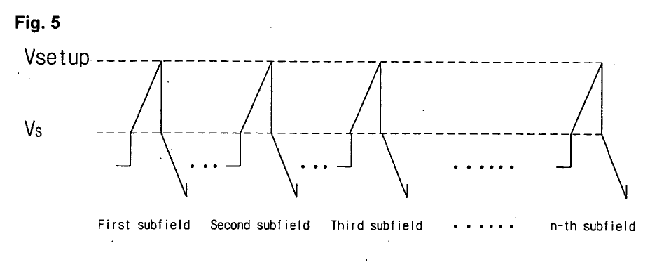

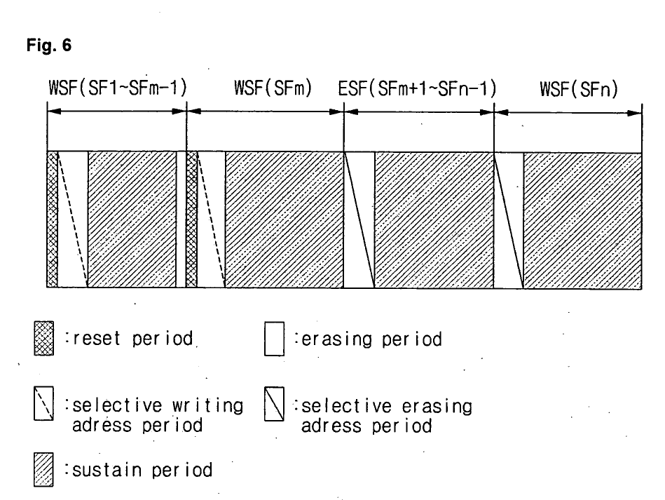

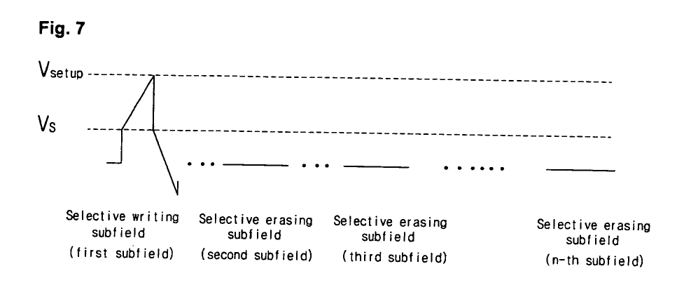

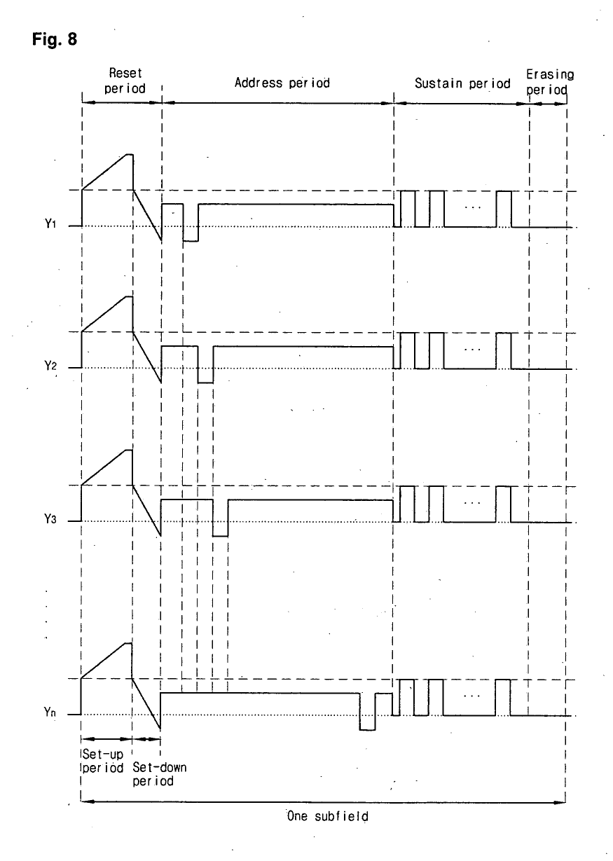

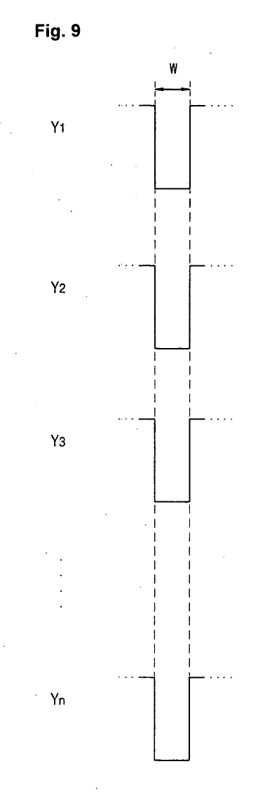

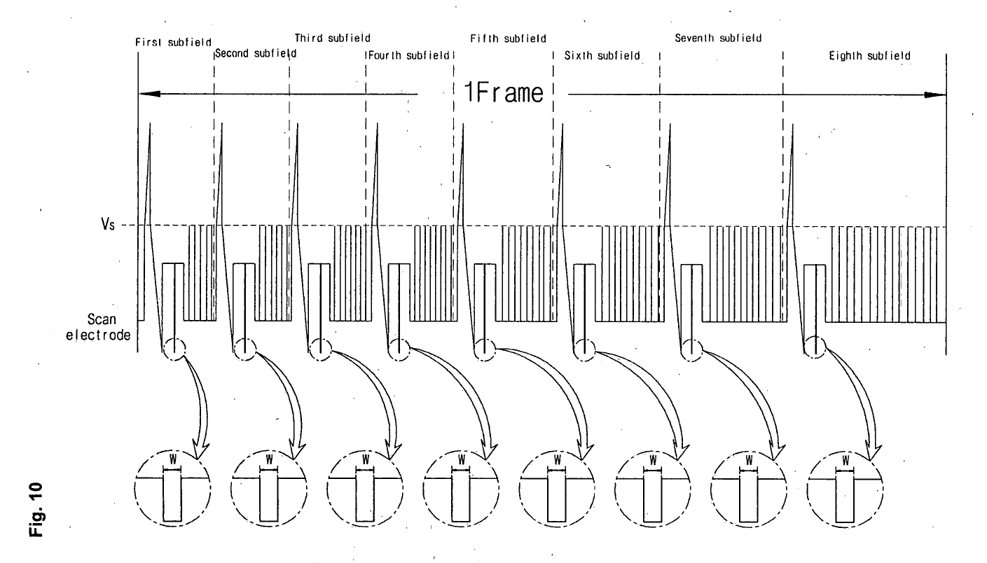

### DETAILED DESCRIPTION OF PREFERRED EMBODIMENTS

Preferred embodiments of the present invention will be described in a more detailed manner with reference to the drawings.

A plasma display apparatus according to the present invention comprises a plasma display panel comprising scan electrodes, a driver driving the scan electrodes, and a reset pulse controller controlling the driver to control the magnitudes of the reset pulses applied to the scan electrodes in the reset periods of at least one sub-field among the sub-fields of one frame in accordance with gray level values.

The magnitudes of the reset pulses have three or more different voltage values and the reset pulse controller increases the magnitudes of the reset pulses according as the gray level values of the sub-fields dcreases.

The reset pulse controller sets the magnitude of at least one of the reset pulses to be more than twice a sustain voltage.

The magnitudes of the reset pulses are more than twice the sustain voltage in the sub-fields from the sub-field having the lowest number of sustain pulses to the sub-field that comes fourth in the order where the sub-field in which the number of sustain pulses supplied in a sustain period is lowest comes first among the sub-fields of the frame.

The magnitudes of the reset pulses are more than twice the sustain voltage in the sub-fields in which a number of sustain pulses is equal to or less than ½ of the total number of sustain pulses of the sub-field in which the highest number of sustain pulses are supplied in a sustain period are supplied among the sub-fields of the frame.

The magnitudes of the reset pulses are more than twice the sustain voltage in the sub-fields in which a number of sustain pulses is equal to or less than 20% of the total number of sustain pulses of one frame are supplied.

The reset pulse controller sets the magnitude of at least one of the reset pulses to be more than the sustain voltage and less than twice the sustain voltage.

The magnitudes of the reset pulses are more than the sustain voltage and smaller than twice the sustain voltage in the sub-fields from the sub-field having the highest number of sustain pulses to the sub-field that comes fourth in the order where the sub-field in which the number of sustain pulses supplied in a sustain period is highest comes first among the sub-fields of the frame.

The magnitudes of the reset pulses are more than the sustain voltage and less than twice the sustain voltage in the sub-fields in which sustain pulses is equal to or more than ½ of the total number of sustain pulses of the sub-field in which the highest number of sustain pulses are supplied in a sustain period are supplied among the sub-fields of the frame.

The magnitudes of the reset pulses are more than the sustain voltage and less than twice the sustain voltage in the sub-fields in which a number of sustain pulses is equal to or more than 20% of the total number of sustain pulses of one frame are supplied.

The reset pulse controller makes at least one of the reset pulses fall with a slope after maintaining a positive voltage of a predetermined magnitude.

The magnitude of the positive voltage is equal to the magnitude of the sustain voltage.

The reset pulse controller irregularly arranges the sub-fields comprised in the frame in the order of the magnitudes of the gray level values.

An apparatus for driving a plasma display panel according to the present invention comprises a driver driving the scan electrodes and a reset pulse controller controlling the driver to control the magnitudes of the reset pulses applied to the scan electrodes in the reset periods of at least one sub-fields among the sub-fields of one frame in accordance with gray level values.

In a plasma display panel according to the present invention, the magnitudes of the reset pulses applied to the scan electrodes in the reset periods of at least one sub-fields among the sub-fields of one frame are controlled in accordance with gray level values.

A plasma display apparatus according to the present invention comprises a plurality of scan electrodes and controller controlling the magnitudes of the reset pulses applied to the scan electrodes in the reset periods of at least one sub-fields among the sub-fields of one frame in accordance with gray level values.

The driver of a plasma display apparatus according to the present invention controls the magnitudes of the reset pulses applied to the scan electrodes in the reset periods of at least one sub-fields among the sub-fields of one frame in accordance with gray level values.

In a method of driving a plasma display apparatus according to the present invention, the magnitudes of the reset pulses applied to the scan electrodes in the reset periods of at least one sub-fields among the sub-fields of one frame are controlled in accordance with gray level values.

A plasma display apparatus according to the present invention comprises a plasma display panel comprising scan electrodes, a driver driving the scan electrodes, and a reset pulse controller controlling the driver to make the magnitudes of the reset pulses applied to the scan electrodes in the reset periods of low gray level sub-fields among the sub-fields of one frame larger than the magnitudes of the reset pulses applied to the scan electrodes in the reset periods of the remaining sub-fields.

The reset pulse controller sets the magnitudes of the reset pulses applied to the scan electrodes in the reset periods of the low gray level sub-fields to be more than twice the sustain voltage.

The low gray level sub-fields are the sub-fields from the sub-field having the lowest number of sustain pulses to the sub-field that comes fourth in the order where the sub-field in which the number of sustain pulses supplied in a sustain period is lowest comes first among the sub-fields of the frame.

The low gray level sub-fields are the sub-fields in which a number of sustain pulses is equal to or less than ½ of the total number of sustain pulses of the sub-field in which the highest number of sustain pulses are supplied in a sustain period are supplied among the sub-fields of the frame.

The low gray level sub-fields are the sub-fields in which a number of sustain pulses is equal to or less than 20% of the total number of sustain pulses of one frame are supplied.

The reset pulse controller irregularly arranges the sub-fields comprised in the frame in the order of the magnitudes of gray level values.

The reset pulse controller sets the reset pulses applied to the scan electrodes in the reset periods of at least one sub-fields among the sub-fields comprised in the frame to fall with a slope after maintaining a positive voltage of a predetermined magnitude.

An apparatus for driving a plasma display panel according to the present invention comprises a driver driving the scan electrodes and a reset pulse controller controlling the driver to set the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

In a plasma display panel according to the present invention, the magnitudes of the reset pulses applied to the scan electrodes in the reset periods of the low gray level sub-fields among the sub-fields of one frame are more than the magnitudes of the reset pulses applied to the scan electrodes in the reset periods of the remaining sub-fields.

A plasma display apparatus according to the present invention comprises a plurality of scan electrodes and controller setting the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

The driver of a plasma display apparatus according to the present invention sets the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

In a method of driving a plasma display apparatus according to the present invention, the magnitudes of the reset pulses applied to the scan electrodes in the reset periods of low gray level sub-fields among the sub-fields of one frame are larger than the magnitudes of the reset pulses applied to the scan electrodes in the reset periods of the remaining sub-fields.

A plasma display apparatus according to the present invention comprises a plasma display panel comprising scan electrodes, a driver driving the scan electrodes, and a reset pulse controller controlling the driver to set the magnitudes of the reset pulses applied to the scan electrodes in the reset periods of the high gray level sub-fields among the sub-fields of one frame to be less than the magnitudes of the reset pulses applied to the scan electrodes in the reset periods of the remaining sub-fields.

The reset pulse controller sets the magnitudes of the reset pulses applied to the scan electrodes in the reset periods of the high gray level sub-fields to be more than the sustain voltage and less than twice the sustain voltage.

The reset pulse controller makes the reset pulses applied to the scan electrodes in the reset periods of at least one sub-fields among the sub-fields comprised in the frame fall with a slope after maintaining a positive voltage of a predetermined magnitude.

The sub-fields in which the reset pulses applied to the scan electrodes in the reset periods fall with a slope after maintaining a positive voltage of a predetermined magnitude are the high gray level sub-fields.

The high gray level sub-fields are the sub-fields from the sub-field having the highest number of sustain pulses to the sub-field that comes fourth in the order where the sub-field in which the number of sustain pulses supplied in a sustain period is highest comes first among the sub-fields of the frame.

The high gray level sub-fields are the sub-fields in which a number of sustain pulses is equal to or more than ½ of the total number of sustain pulses of the sub-field in which the highest number of sustain pulses are supplied in a sustain period are supplied among the sub-fields of the frame.

The high gray level sub-fields are the sub-fields in which a number of sustain pulses is equal to or more than 20% of the total number of sustain pulses of one frame are supplied.

The reset pulse controller irregularly arranges the sub-fields comprised in the frame in the order of the magnitudes of the gray level values.

An apparatus for driving a plasma display panel according to the present invention comprises a driver driving the scan electrodes and a reset pulse controller controlling the driver to set the magnitudes of the reset pulses applied to the scan electrodes in the reset periods of high gray level sub-fields among the sub-fields of one frame to be less than the magnitudes of the reset pulses applied to the scan electrodes in the reset periods of the remaining sub-fields.

In a plasma display panel according to the present invention, the magnitudes of the reset pulses applied to the scan electrodes in the reset periods of the high gray level sub-fields among the sub-fields of one frame are less than the magnitudes of the reset pulses applied to the scan electrodes in the reset periods of the remaining sub-fields.

A plasma display apparatus according to the present invention comprises a plurality of scan electrodes and controller setting the magnitudes of the reset pulses applied to the scan electrodes in the reset periods of high gray level sub-fields among the sub-fields of one frame to be less than the magnitudes of the reset pulses applied to the scan electrodes in the reset periods of the remaining sub-fields.

The driver of a plasma display apparatus according to the present invention sets the magnitudes of the reset pulses applied to the scan electrodes in the reset periods of high gray level sub-fields among the sub-fields of one frame to be less than the magnitudes of the reset pulses applied to the scan electrodes in the reset periods of the remaining sub-fields.

In a method of driving a plasma display apparatus according to the present invention, the magnitudes of the reset pulses applied to the scan electrodes in the reset periods of high gray level sub-fields among the sub-fields of one frame are less than the magnitudes of the reset pulses applied to the scan electrodes in the reset periods of the remaining sub-fields.

A plasma display apparatus according to the present invention comprises a plasma display panel comprising scan electrodes, a driver driving the scan electrodes, and a scan pulse controller controlling the driver to set the width of the scan pulses applied to one or more scan electrode group among a plurality of scan electrode groups comprising the one or more scan electrodes in one or more sub-fields of one frame in the order of scanning to be different from the width of the scan pulses applied to the remaining scan electrode groups.

The scan pulse controller makes one or more scan electrodes group among the plurality of scan electrode groups comprise a plurality of scan electrodes and makes the plurality of scan electrodes comprised in the scan electrode group are continuously scanned.

The plurality of scan electrode groups comprise a first scan electrode group and a second electrode group that is scanned later than the first scan electrode group and the width of the scan pulses applied to the first scan electrode group is narrower than the width of the scan pulses applied to the second electrode group.

The scan pulse controller sets the number of scan electrodes no less than 2 and no more than the total number of scan electrodes.

The scan pulse controller ensures that each of the scan electrode groups comprise the same number of scan electrodes.

The scan pulse controller ensures that one or more of the scan electrode groups comprise a number of scan electrodes whose number that is different from the number of scan electrodes of the remaining scan electrode groups.

The scan pulse controller applies scan pulses of the same width are applied to all of the scan electrodes comprised in the same scan electrode group.

The scan pulse controller sets a difference in width between any two scan pulses that are used for scanning of any two continuous scan electrode groups to be the same as the difference in width between other two scan pulses that are used for scanning of other two continuous scan electrode groups.

The scan pulse controller sets a difference in width between any two scan pulses that are used for scanning of any two continuous scan electrode groups to be different from the difference in width between other two scan pulses that are used for scanning of other two continuous scan electrode groups.

An apparatus for driving a plasma display panel according to the present invention comprises a driver driving the scan electrodes and a scan pulse controller controlling the driver to set the width of the scan pulses applied to one or more scan electrode group among a plurality of scan electrode groups comprising the one or more scan electrodes in one or more sub-fields of one frame in the order of scanning to be different from the width of the scan pulses applied to the remaining scan electrode groups.

In a plasma display panel according to the present invention, the width of the scan pulses applied to one or more scan electrode group among a plurality of scan electrode groups comprising the one or more scan electrodes in one or more sub-fields of one frame in the order of scanning is different from the width of the scan pulses applied to the remaining scan electrode groups.

In a method of driving a plasma display apparatus according to the present invention, the width of the scan pulses applied to one or more scan electrode group among a plurality of scan electrode groups comprising the one or more scan electrodes in one or more sub-fields of one frame in the order of scanning is different from the width of the scan pulses applied to the remaining scan electrode groups.

A plasma display apparatus according to the present invention comprising a plasma display panel comprising scan electrodes, a driver driving the scan electrodes, and a scan pulse controller controlling the driver to control the widths of the scan electrodes applied to the scan electrodes in one or more sub-fields of one frame in accordance with an average picture level (APL).

The scan pulse controller sets the widths of the scan pulses applied to the scan electrodes in the same sub-field to be the same.

The scan pulse controller sets the widths of the scan pulses of low gray level sub-fields among the sub-fields to increase as the APL decreases.

The scan pulse controller makes the widths of the scan pulses of the remaining sub-fields excluding the low gray level sub-fields to decrease as the APL decreases.

The scan pulse controller sets the low gray level sub-fields to be plural and sets the widths of the scan pulses of the plurality of low gray level sub-fields to be the same.

The scan pulse controller sets the low gray level sub-fields to be plural and sets the width of the scan pulses of one or more of the plurality of low gray level sub-fields to be different from the width of the scan pulses of the remaining low gray level sub-fields.

The low gray level sub-fields are the sub-fields having a number of sustain pulses that is equal to or less than 20% of the number of sustain pulses of the sub-field having the highest number of sustain pulses in one frame.

The scan pulse controller sets the widths of the scan pulses of high gray level sub-fields among the sub-fields to increase according as the APL of the frame increases.

The widths of the scan pulses of the remaining sub-fields excluding the high gray level sub-fields decreases.

The scan pulse controller sets the high gray level sub-fields to be plural and sets the widths of the scan pulses of the plurality of high gray level sub-fields to be the same.

The the scan pulse controller sets the high gray level sub-fields to be plural and sets the width of the scan pulses of one or more of the plurality of high gray level sub-fields to be different from the width of the scan pulses of the remaining high gray level sub-fields.

The high gray level sub-fields are the sub-fields having a number of sustain pulses that is equal to or more than 20% of the total number of sustain pulses supplied in one frame.

The scan pulse controller sets the difference in width between the scan pulses of continuous two sub-fields having scan pulses of different widths among the sub-fields of the frame to be the same.

The scan pulse controller sets the difference in width between the scan pulses of continuous two sub-fields having scan pulses of different widths among the sub-fields of the frame to vary.

An apparatus for driving a plasma display panel according to the present invention comprises a driver driving the scan electrodes and a scan pulse controller controlling the driver to control the widths of the scan pulses applied to the scan electrodes in one or more sub-field of one frame in accordance with an APL.

In a plasma display panel according to the present invention, the widths of the scan pulses applied to the scan electrodes are controlled in one or more sub-field of one frame in accordance with an APL.

In a method of driving a plasma display apparatus according to the present invention, the widths of the scan pulses applied to the scan electrodes are controlled in one or more sub-field of one frame in accordance with an APL.

Hereinafter, specific embodiments of the present invention will be described with reference to the attached drawings.

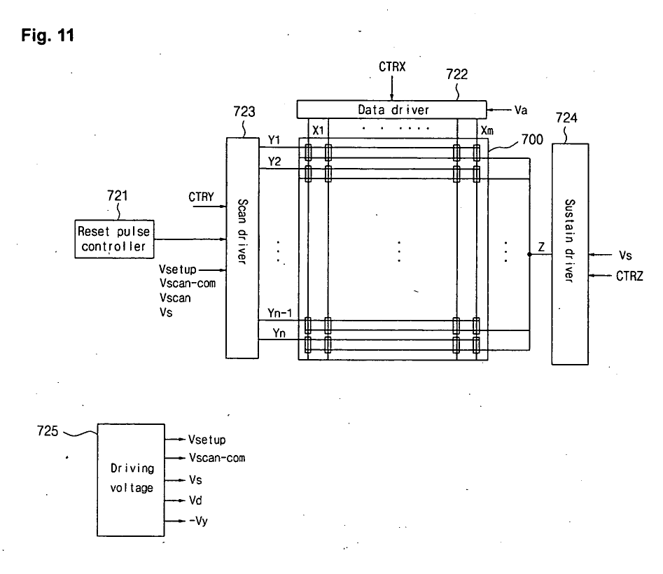

FIG. 11 illustrates a plasma display apparatus for applying reset pulses according to the present invention. As illustrated in FIG. 11, the plasma display apparatus according to the present invention comprises a plasma display panel (PDP) 700, a data driver 722, a scan driver 723, a sustain driver 724, and a reset pulse controller 721.

For example, as illustrated in FIG. 11, the plasma display apparatus according to the present invention comprises the PDP 700 for displaying an image comprising a frame by combination of one or more sub-fields in which driving pulses are applied to the address electrodes X1 to Xm, the scan electrodes Y1 to Yn, and the sustain electrodes Z in a reset period, an address period, and a sustain period, the data driver 722 for supplying data to the address electrodes X1 to Xm formed on the bottom surface panel (not shown) of the PDP 700, the scan driver 723 for driving the scan electrodes Y1 to Yn, the sustain driver 724 for driving the sustain electrodes Z that are common electrodes, the reset pulse controller 721 for controlling the scan driver 723 when the PDP 700 is driven to control the magnitudes of the reset pulses, and a driving voltage generator 725 for supplying a driving voltage required for the driver 722, 723 and 724.

As described above, the plasma display apparatus for applying the reset pulses according to the present invention displays an image comprising a frame by combination of one or more sub-fields in which the driving pulses are applied to the address electrodes, the scan electrodes, and the sustain electrodes in the reset period, the address period, and the sustain period and controls the magnitude of the reset pulse applied to the scan electrodes in the reset period of at least one sub-field among the sub-fields of the frame in accordance with the value of a gray level.

The PDP 700 comprises a top surface panel (not shown) and a bottom surface panel (not shown) combined with each other so that the top surface panel and the bottom surface panel are separated from each other by a predetermined distance. In the top surface panel, a plurality of electrodes, for example, the scan electrodes Y1 to Yn and the sustain electrodes Z are formed to make pairs. In the bottom surface panel, the address electrodes X1 to Xm are formed to intersect the scan electrodes Y1 to Yn and the sustain electrodes Z.

Data that are inverse gamma corrected and error diffused by an inverse gamma correcting circuit(not shown) and an error diffusing circuit(not shown), are mapped by a sub-field mapping circuit in the sub-fields are supplied to the data driver 722. The data driver 722 samples and latches the data in response to data timing control signals CTRX from a timing controller (not shown) and then, supplies the data to the address electrodes X1 to Xm.

The scan driver 723 supplies the reset pulses whose magnitudes are controlled in accordance with the gray level values of the sub-fields to the scan electrodes Y1 to Yn under the control of the reset pulse controller 721 in the reset period. Also, the scan driving part 723 sequentially supplies scan pulses Sp of a scan voltage −Vy to the scan electrodes Y1 to Yn in the address period and supplies sustain pulses sus to the scan electrodes Y1 to Yn in the sustain period.

The sustain driver 724 supplies the bias voltage of a sustain voltage Vs to the sustain electrodes Z under the control of the timing controller (not shown) in a period where a falling ramp waveform Ramp-down is generated and in the address period and alternates the scan driver 723 in the sustain period to supply the sustain pulses sus to the sustain electrodes Z.

The reset pulse controller 721 generates predetermined control signals for controlling the operating timing and synchronization of the scan driver 723 in the reset period and supplies the timing control signals to the scan driver 723 to control the scan driver 723. In particular, the reset pulse controller 721 supplies the control signals to the scan driver 723 to control the magnitude of the reset pulse applied to the scan electrodes in the reset period of one sub-field of a frame in accordance with the value of a gray level. Also, the reset pulse controller 721 supplies the control signals to the scan driver 723 so that the magnitudes of the reset pulses have three or more different voltage values and so that the magnitudes of the reset pulses having the three or more different voltage values decrease as the gray level values of the corresponding sub-fields decrease.

On the other hand, the data control signals CTRX comprise a sampling clock for sampling data, a latch control signal, and a switch control signal for controlling the on/off times of an energy frequency circuit and a driving switch device. A scan control signal CTRY comprises a switch control signal for controlling the on/off times of the energy frequency circuit and the driving switch device in the scan driver 723. A sustain control signal CTRZ comprises a switch control signal for controlling the on/off times of the energy frequency circuit and the driving switch device in the sustain driver 724.

The driving voltage generator 725 generates a set-up voltage Vsetup, a scan common voltage Vscan-com, the scan voltage −Vy, the sustain voltage Vs, and a data voltage Vd. The driving voltages may vary in accordance with the composition of discharge gas or the structure of a discharge cell.

The function of the plasma display apparatus for applying the reset pulses according to the present invention of FIG. 11 will be clarified in the method of driving the plasma display apparatus that will be described hereinafter.

Another plasma display apparatus according to the present invention is the same as the plasma display apparatus according to the present invention of FIG. 11 excluding that the reset pulse controller 721 generates predetermined control signals for controlling the operation timing and synchronization of the scan driver 723 in the reset period and supplies the timing control signals to the scan driver 723 to control the scan driver 723 and, in particular, applies predetermined control signals to the scan driver 723 so that the magnitude of the reset pulses applied to the scan electrodes in the reset periods of low gray level sub-fields among the sub-fields of the frame is more than the magnitude of the reset pulses applied to the scan electrodes in the reset periods of the remaining sub-fields.

The function of another plasma display apparatus according to the present invention having such a structure will be clarified in the method of driving the plasma display apparatus that will be described hereinafter.

Another plasma display apparatus according to the present invention is the same as the plasma display apparatus according to the present invention of FIG. 11 excluding that the reset pulse controller 721 generates predetermined control signals for controlling the operation timing and synchronization of the scan driver 723 in the reset period and supplies the timing control signals to the scan driver 723 to control the scan driver 723 and, in particular, applies predetermined control signals to the scan driver 723 so that the magnitude of the reset pulses applied to the scan electrodes in the reset periods of the high gray level sub-fields among the sub-fields of the frame is less than the magnitude of the reset pulses applied to the scan electrodes in the reset periods of the remaining sub-fields.

### First Embodiment

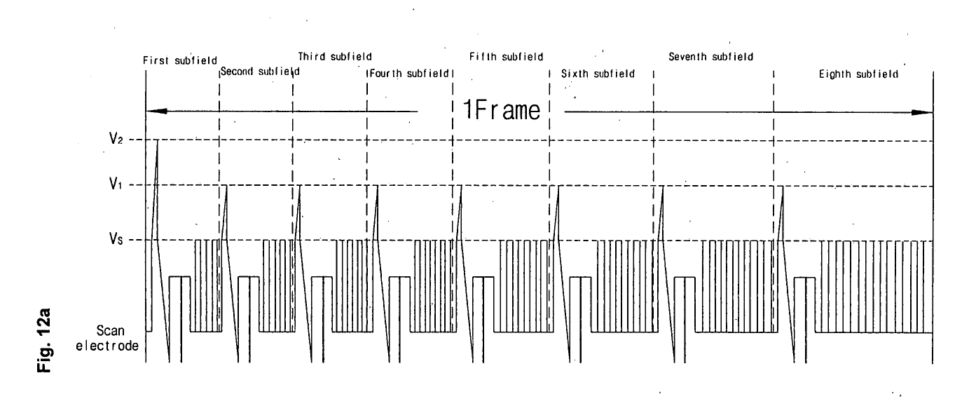

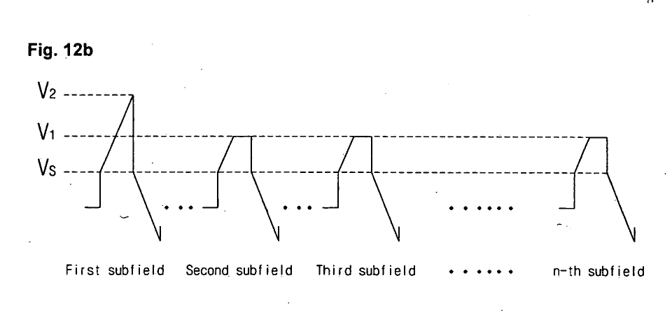

An embodiment of the method of driving the plasma display apparatus according to the present invention will be described in FIG. 12.

FIGS. 12A and 12B illustrate the first embodiment of the method of driving the plasma display apparatus for applying the reset pulses according to the present invention.

As illustrated in FIGS. 12A and 12B, according to the first embodiment of the method of driving the plasma display apparatus comprising the scan electrodes, the sustain electrodes, and the plurality of address electrodes that intersect the scan electrodes and the sustain electrodes, the magnitude of the reset pulses applied to the scan electrodes in the reset periods of low gray level sub-fields among the sub-fields of one frame is larger than the magnitude of the reset pulses applied to the scan electrodes in the reset periods of the remaining sub-fields.

For example, as illustrated in FIG. 12A, when one frame comprises eight sub-fields, the magnitude V2 of the reset pulse applied to the scan electrodes in the reset period of the first sub-field which has the lowest brightness weight value to realize the lowest gray level, that is, the magnitude of the first sub-field is more than the magnitude V1 of the reset pulses in the remaining sub-fields, that is, the second, third, fourth, fifth, sixth, seventh, and eighth sub-fields.

The magnitude V2 of the reset pulse applied to the scan electrodes in the reset period of the low gray level sub-field is preferably more than twice the sustain voltage Vs, that is, 2Vs.

The reason why the magnitude of the reset pulse in the low gray level sub-field among the sub-fields of one frame is more than the magnitude of the reset pulses in the remaining sub-fields, preferably, more than 2Vs as described above will be described as follows.

It is more likely that an address discharge is unstable in a gray level sub-fields that have lower brightness weight values than in sub-fields that have higher brightness weight values. Therefore, when the magnitude of the reset pulse applied to the scan electrodes in the reset period is excessively low, wall charges are not uniformly distributed in a discharge cell thereby causing an unstable address discharge and an unstable sustain discharge after the reset periods deterioration of address jitter. Therefore, the magnitude of the reset pulses applied in the reset periods of the low gray level sub-fields that have lower brightness weight values is more than the magnitude of the reset-pulses applied in the reset periods of the remaining sub-fields so that the address discharge in the low gray level sub-fields that have lower brightness weight values is stable. As described above, when the address discharge is stable, it is possible to prevent the driving margin of the entire plasma display apparatus from deteriorating.

In high gray level sub-fields that have higher brightness weight values, the magnitude of the reset pulses applied to the scan electrodes in the reset periods is less than the magnitude of the reset pulses applied to the scan electrodes in the reset periods of the low gray level sub-fields. Therefore, the magnitude of the unnecessary discharge that does not contribute to display of an image, which is generated by the reset pulses of the high gray level sub-fields, decreases thereby improving contrast.

The reset pulses of FIG. 12A whose magnitudes are controlled in accordance with the gray level values of the sub-fields will be described in detail with reference to FIG. 12B.

Referring to FIG. 12B, the magnitude V2 of the reset pulse in the first sub-field is highest and the magnitude of the reset pulses in the remaining sub-fields is lower than the magnitude of the reset pulse in the first sub-field. In FIG. 12B, the slope of the rising ramp Ramp-up of the reset pulse in the first sub-field is the same as the slope of the rising ramps of the reset pulses in the second, third, fourth, fifth, sixth, seventh, and eighth sub-fields. However, the value of the maximum voltage of the reset pulse in the first sub-field is different from the value of the maximum voltage of the reset pulses in the second, third, fourth, fifth, sixth, seventh, and eighth sub-fields. As described above, when the slopes of the rising ramps are the same in all of the sub-fields, it is possible to generate the rising ramps in all of the sub-fields, that is, the first to eighth sub-fields using the same set-up pulse generating circuit (not shown) in terms of the structure of the circuit for generating the rising ramps so that it is possible to easily control the circuit.

The low gray level sub-fields may be determined in accordance with the number of sustain pulses supplied in the sustain periods of the sub-fields of the frame. For example, a number of sustain pulses that is equal to or less than ½ of the total number of sustain pulses of the sub-fields in which the highest number of sustain pulses are supplied in the sustain periods among the sub-fields of the frame are preferably supplied to the low gray level sub-fields. For example, when it is assumed that the sub-field having the highest number of sustain pulses among the sub-fields comprised in one frame comprises 1,000 sustain pulses, the sub-fields that comprise 500 or less sustain pulses are the low gray level sub-fields.

The sub-field with a number of sustain pulses that is equal to or less than 20% of the total number of the sustain pulses of one frame are supplied may be the low gray level sub-field. For example, when the number of sustain pulses generated in one frame is 2,000, the sub-field in which is equal or less than 400 sustain pulses are supplied is the low gray level sub-field.

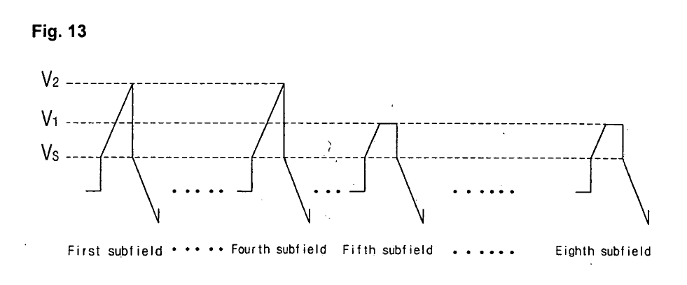

The low gray level sub-fields may also be determined as the order that the sub-field having the lowest number of sustain pulses comes first in one frame. An example of this method of determining the low gray level sub-fields will be described with reference to FIG. 13.

FIG. 13 illustrates an example of a method of determining the low gray level sub-fields according to the first embodiment of the method of driving the plasma display apparatus for applying the reset pulses according to the present invention.

As illustrated in FIG. 13, a plurality of sub-fields are low gray level sub-fields in one frame so that the sub-fields from the sub-field having the lowest number of sustain pulses to the sub-field that comes fourth in the order where the sub-field having the lowest number of sustain pulses comes first, are the low gray level sub-fields. For example, when it is assumed that one frame is composed of eight sub-fields, the first sub-field that has the lowest number of sustain pulses, that is, that has the lowest brightness weight value, the third sub-field, and the fourth sub-field are determined as the low gray level sub-fields.

The magnitude of the reset pulses in the low gray level sub-fields determined as described above is more than the magnitude of the reset pulses in the remaining sub-fields. That is, as illustrated in FIG. 13, the magnitude V2 of the reset pulses applied to the scan electrodes in the reset periods of the first, second, third, and fourth sub-fields determined as the low gray level sub-fields is more than the magnitude of the reset pulses applied to the scan electrodes in the reset periods of the remaining sub-fields, that is, more than 2Vs and the magnitude V1 of the reset pulses applied to the scan electrodes in the reset periods of the remaining sub-fields is less than the magnitude V2.

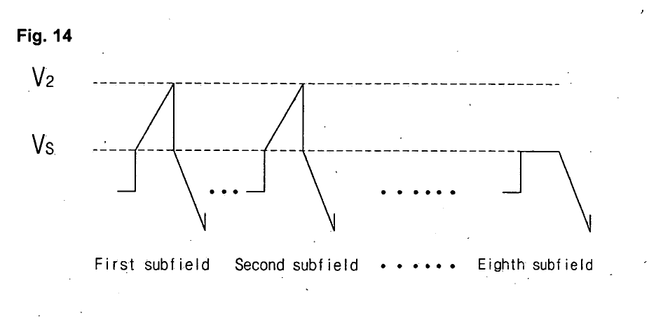

As described above, in the remaining sub-fields except for the low gray level sub-fields, for example, in the fifth to eighth sub-fields of FIG. 13, the reset pulses comprise the rising ramps Ramp-up that rise with a predetermined slope. The reset pulses may be applied so that the rising ramps are not comprised in the reset period of an arbitrary sub-field of the frame. Such a driving waveform will be described with reference to FIG. 14.

FIG. 14 illustrates another driving waveform according to the first embodiment of the method of driving the plasma display apparatus for applying the reset pulses according to the present invention.

As illustrated in FIG. 14, in another driving waveform according to the first embodiment of the method of driving the plasma display apparatus for applying the reset pulses according to the present invention, the rising ramp Ramp-up that rises with a predetermined slope is omitted from the reset pulse applied to the scan electrodes in the reset period of at least one sub-field among the sub-fields of one frame. For example, as illustrated in FIG. 14, the reset pulse in the eighth sub-field has a waveform of a falling ramp Ramp-down that falls with a predetermined slope after maintaining a predetermined positive voltage. The rising ramp is omitted from the reset pulse of the eighth sub-field compared with the reset pulses applied to the scan electrodes in the reset periods of the remaining sub-fields, that is, the first to seventh sub-fields. In the period where the rising ramps are applied in the remaining sub-fields, the predetermined positive voltage, for example, the sustain voltage Vs is maintained in the eighth sub-field and then, the waveform of the falling ramp is shown.

As described above, the sub-field in which the reset pulse from which the rising ramp is omitted is applied is preferably a high gray level sub-field that has a higher brightness weight value. Therefore, in the reset period of the high gray level sub-field in which the discharge is stable, the magnitude of the reset pulse, in particular, the magnitude of the unnecessary discharge that does not contribute to display of an image, which is generated by the rising ramp, is reduced to improve the contrast.

With respect to a driving circuit, since it is not necessary to supply the set-up voltage having the pulse shape of the rising ramp, it is possible to easily control the driving circuit.

Since it is not necessary to supply the rising ramp of a higher voltage, it is also possible to reduce power consumption.

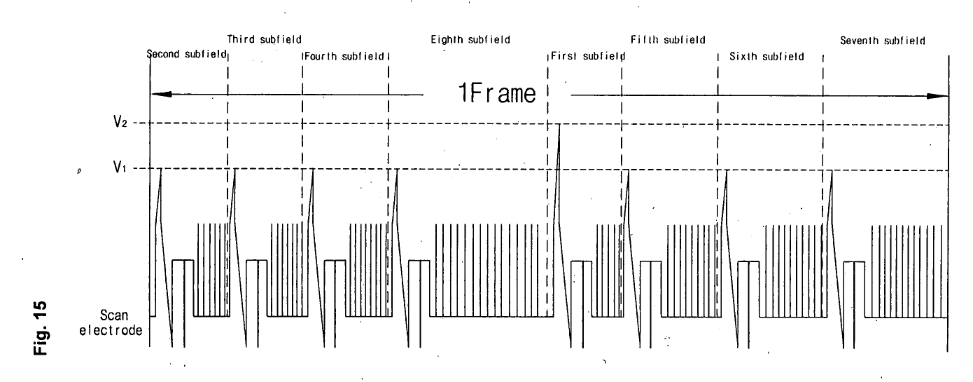

The sub-fields may also be irregularly arranged in one frame. One example of such a driving method will be described with reference to FIG. 15.

FIG. 15 illustrates the arrangement of the sub-fields in one frame according to the first embodiment of the method of driving the plasma display apparatus for applying the reset pulses according to the present invention.

As illustrated in FIG. 15, the sub-fields in one frame are not regularly arranged in the order of the magnitudes of the brightness weight values, that is, the magnitudes of the gray level values but are randomly arranged regardless of the magnitude of the gray level value. In the frame where the sub-fields are irregularly arranged, the magnitude of the reset pulse applied to the scan electrodes in the reset period of the sub-field that comes fifth, which is the low gray level sub-field that has the smallest brightness weight value, that is, the first sub-field is more than the magnitude of the reset pulses applied to the scan electrodes in the reset period of the remaining sub-fields.

When the sub-fields are arranged in the order of the first, second, third, fourth, fifth, sixth, seventh, and eighth sub-fields in FIG. 12A, the sub-fields are arranged in the order of the second, third, fourth, eighth, first, fifth, sixth, and seventh sub-fields in FIG. 15. In FIG. 15, the sub-fields are randomly arranged regardless of the magnitude of the brightness weight value. The high gray level sub-fields that have higher brightness weight values, that is, higher gray level values and low gray level sub-fields that have lower brightness weight values, that is, lower gray level values may be alternately arranged in one frame. The present invention is not limited to such an arrangement of sub-fields. What matters is that the magnitude of the reset pulses applied to the scan electrodes in the reset periods of the low gray level sub-fields among the sub-fields comprised in the frame must be more than the magnitude of the reset pulses applied to the scan electrodes in the reset periods of the remaining sub-fields regardless of how the sub-fields are arranged in the frame.

### Second Embodiment

According to the first embodiment of the method of driving the plasma display apparatus, the magnitude of the reset pulses is controlled in the low gray level sub-fields among the sub-fields in one frame. However, the magnitude of the reset pulses may also be controlled in the high gray level sub-fields among the sub-fields in one frame, which will be described with reference to a second embodiment of the method of driving the plasma display apparatus for applying the reset pulses according to the present invention.

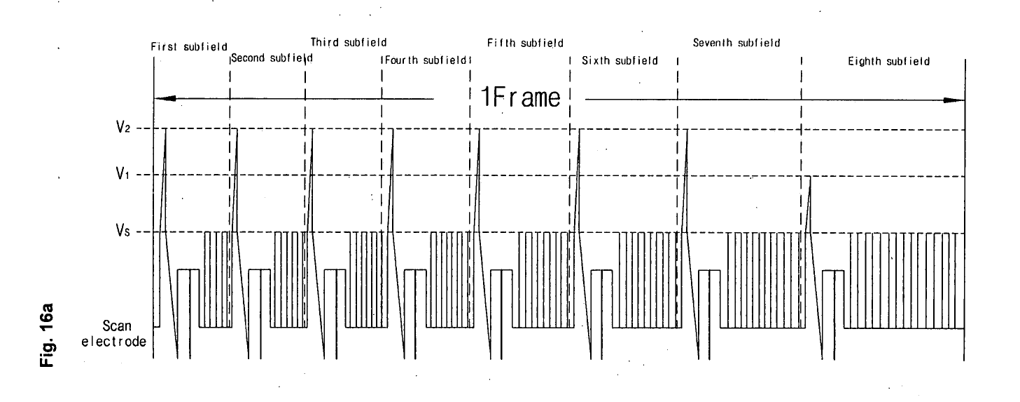

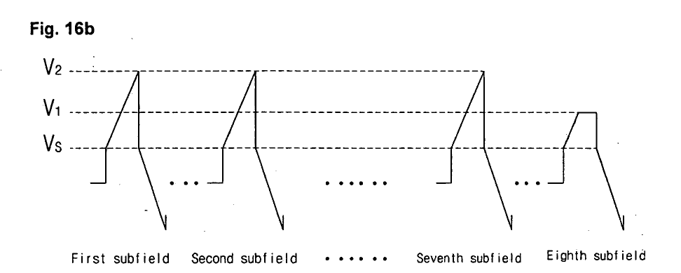

FIGS. 16A and 16B illustrates the second embodiment of the method of driving the plasma display apparatus for applying the reset pulses according to the present invention.

As illustrated in FIGS. 16A and 16B, according to the second embodiment of the method of driving the plasma display apparatus comprising the scan electrodes, the sustain electrodes, and the plurality of address electrodes that intersect the scan electrodes and the sustain electrodes, the magnitude of the reset pulses applied to the scan electrodes in the reset periods of the high gray level sub-fields among the sub-fields of one frame is less than the magnitude of the reset pulses applied to the scan electrodes in the reset periods of the remaining sub-fields.

For example, as illustrated in FIG. 16A, when one frame comprises eight sub-fields, the magnitude V1 of the reset pulse applied to the scan electrodes in the reset period of the last sub-field, which has the highest brightness weight value, that is, the eighth sub-field is smaller than the magnitude V2 of the reset pulses in the remaining sub-fields, that is, the first, second, third, fourth, fifth, sixth, and seventh sub-fields.

The magnitude V1 of the reset pulse applied to the scan electrodes in the reset period of the high gray level sub-field is preferably less than twice the sustain voltage Vs, that is, 2Vs and more than the sustain voltage Vs. That is, a relationship of Vs<V1<2Vs is established.

The reason why the magnitude of the reset pulse in the high gray level sub-field among the sub-fields of one frame is smaller than the magnitude of the reset pulses in the remaining sub-fields as described above will be described as follows.

An address discharge is less likely to be unstable in high gray level sub-fields that have higher brightness weight values than in the low sub-fields that have lower brightness weight values. Therefore, in the high gray level sub-fields, it is possible to uniformly distribute wall charges in a discharge cell although the magnitude of the reset pulses applied to the scan electrodes in the reset periods are less than the magnitude of the reset pulses applied to the scan electrodes in the reset periods of the low gray level sub-fields. Therefore, in the high gray level sub-fields, although reset pulses having lower voltages are supplied, the address discharge after the reset periods becomes stable compared with the remaining low gray level sub-fields so that it is possible to prevent address jitter from deteriorating and to prevent unstable sustain discharge after the reset periods. As a result, the magnitude of the reset pulses applied in the reset periods of the high gray level sub-fields that have higher brightness weight values is less than the magnitude of the reset pulses applied in the reset periods of the remaining sub-fields so that the discharge of the plasma display panel is stable and the magnitude of the unnecessary discharge that does not contribute to display of an image, which is generated by the reset pulses, decreases to improve the contrast.

The reset pulses of FIG. 16A whose magnitude is controlled in accordance with the gray level values of the sub-fields will be described in detail with reference to FIG. 16B.

Referring to FIG. 16B, the magnitude V1 of the reset pulse in the eighth sub-field is the lowest and the magnitude of the reset pulses in the remaining sub-fields is more than the magnitude of the reset pulse in the eighth sub-field. In FIG. 16B, the slope of the rising ramp Ramp-up of the reset pulse in the eighth sub-field is the same as the slope of the rising ramps of the reset pulses in the first, second, third, fourth, fifth, sixth, and seventh sub-fields. However, the value of the maximum voltage of the reset pulse in the eighth sub-field is different from the value of the maximum voltage of the reset pulses in the first, second, third, fourth, fifth, sixth, and seventh sub-fields. As described above, when the slopes of the rising ramps are the same in all of the sub-fields, it is possible to generate the rising ramps in all of the sub-fields, that is, the first to eighth sub-fields using the same set-up pulse generating circuit (not shown) in terms of the structure of the circuit for generating the rising ramps to easily control the circuit.

The high gray level sub-fields may be determined in accordance with the number of sustain pulses supplied in the sustain periods of the sub-fields of the frame. For example, a number of sustain pulses that is equal to or more than ½ of the total number of sustain pulses of the sub-fields in which the highest number of sustain pulses are supplied in the sustain periods among the sub-fields of the frame are preferably supplied to the high gray level sub-fields. For example, when the sub-field having the largest number of sustain pulses among the sub-fields comprised in one frame comprises 1,000 sustain pulses, the sub-fields that comprise 500 or more 500 sustain pulses are determined as the high gray level sub-fields.

The sub-field in which the number of sustain pulses is equal to or more than 20% of the total number of the sustain pulses supplied in one frame are determined as the high gray level sub-field. For example, when the number of sustain pulses generated in one frame is 2,000, the sub-field in which 400 or more sustain pulses are supplied is determined as the high gray level sub-field.

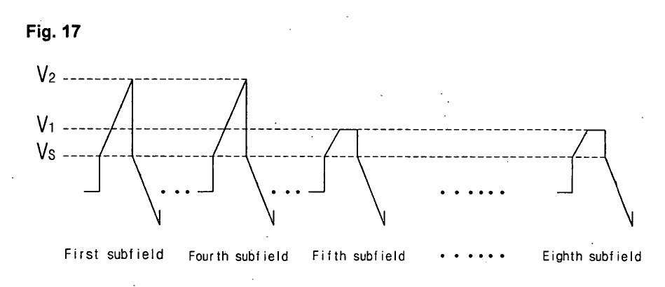

The high gray level sub-fields may also be determined in the order where the sub-field having the highest number of sustain pulses comes first in one frame. An example of such a manner of determining the high gray level sub-fields will be described with reference to FIG. 17.

FIG. 17 illustrates an example of a method of determining the high gray level sub-fields according to the second embodiment of the method of driving the plasma display apparatus for applying the reset pulses according to the present invention.

As illustrated in FIG. 17, a plurality of sub-fields are determined as the high gray level sub-fields in one frame so that the sub-fields from the sub-field having the largest number of sustain pulses to the sub-field that comes fourth in the order where the sub-field having the largest number of sustain pulses comes first are determined as the high gray level sub-fields among the plurality of sub-fields in one frame. For example, when one frame comprises eight sub-fields, the eighth sub-field that has the highest number of sustain pulses, that is, that has the highest brightness weight value, the seventh sub-field, the sixth sub-field, and the fifth sub-field in the order where the sub-field having the highest number of sustain pulses comes first are determined as the high gray level sub-fields.

The magnitude of the reset pulses in the high gray level sub-fields determined as described above is less than the magnitude of the reset pulses in the remaining sub-fields. That is, as illustrated in FIG. 17, the magnitude V1 of the reset pulses applied to the scan electrodes in the reset periods of the fifth, sixth, seventh and eighth sub-fields are determined as the high gray level sub-fields is less than the magnitude of the reset pulses applied to the scan electrodes in the reset periods of the remaining sub-fields, that is, more than the sustain voltage Vs and less than twice the sustain voltage 2Vs. The magnitude V2 of the reset pulses applied to the scan electrodes in the reset periods of the remaining sub-fields is more than the magnitude V1.

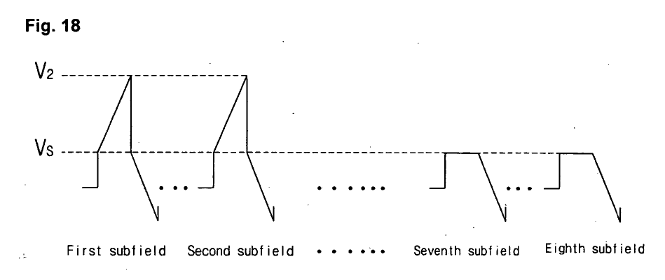

As described above, in the high sub-fields, for example, in the fifth to eighth sub-fields of FIG. 17, the reset pulses comprise the rising ramps Ramp-up that rise with a predetermined slope. The reset pulses, however, may also be applied so that the rising ramps are not comprised in the reset period of at least one sub-field of the frame. Such a driving waveform will be described with reference to FIG. 18.

FIG. 18 illustrates another driving waveform according to the second embodiment of the method of driving the plasma display apparatus for applying the reset pulses according to the present invention.

As illustrated in FIG. 18, in another driving waveform according to the second embodiment of the method of driving the plasma display apparatus for applying the reset pulses according to the present invention, the rising ramp Ramp-up that rises with a predetermined slope is omitted from the reset pulse applied to the scan electrodes in the reset period of at least one sub-field among the sub-fields of one frame. For example, as illustrated in FIG. 18, the reset pulses in the seventh and eighth sub-fields have a waveform of a falling ramp Ramp-down that falls with a predetermined slope after maintaining a predetermined positive voltage. The rising ramp is omitted from the reset pulses of the seventh and eighth sub-fields compared with the reset pulses applied to the scan electrodes in the reset periods of the remaining sub-fields, that is, the first to sixth sub-fields. In the period where the rising ramps are applied in the remaining sub-fields, the predetermined positive voltage, for example, the sustain voltage Vs is maintained in the seventh and eighth sub-fields and then, the falling ramp Ramp-down is formed.

As described above, the sub-field in which the reset pulse with the omitted rising ramp is applied is preferably a high gray level sub-field that has a higher brightness weight value. Therefore, in the reset period of the high gray level sub-field in which discharge is stable unlike, the magnitude of the reset pulse, in particular, the magnitude of the unnecessary discharge that does not contribute to display of an image, which is generated by the rising ramp, decreases to improve the contrast.

In terms of a driving circuit, since it is not necessary to supply the set-up voltage having the waveform of the rising ramp, it is possible to easily control the driving circuit.

Since it is not necessary to supply the rising ramp of a higher voltage, it is possible to reduce power consumption.

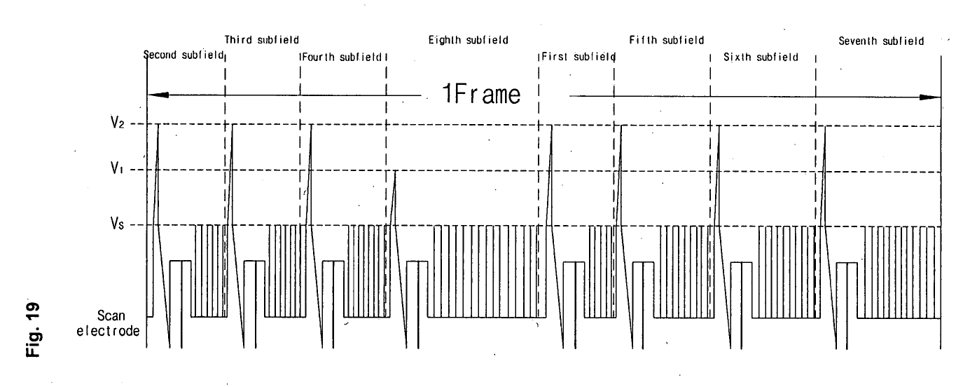

The sub-fields may also be irregularly arranged in one frame. One example of such a driving method will be described with reference to FIG. 19.

FIG. 19 illustrates the arrangement of the sub-fields in one frame according to the second embodiment of the method of driving the plasma display apparatus for applying the reset pulses according to the present invention.

As illustrated in FIG. 19, the sub-fields in one frame are not regularly arranged in the order of the magnitudes of the brightness weight values, that is, the magnitudes of the gray level values but are randomly arranged regardless of the magnitude of the gray level value. In the frame where the sub-fields are irregularly arranged, the magnitude of the reset pulse applied to the scan electrodes in the reset period of the sub-field that comes fourth, which is the high gray level sub-field that has the highest value, that is, the eighth sub-field is less than the magnitude of the reset pulses applied to the scan electrodes in the reset period of the remaining sub-fields.

When the sub-fields are arranged in the order of the first, second, third, fourth, fifth, sixth, seventh, and eighth sub-fields in FIG. 16A, the sub-fields are arranged in the order of the second, third, fourth, eighth, first, fifth, sixth, and seventh sub-fields in FIG. 19. In FIG. 19, the sub-fields are randomly arranged regardless of the magnitude of the brightness weight value. The high gray level sub-fields that have higher brightness weight values, that is, higher gray level values and low gray level sub-fields that have lower brightness weight values, that is, lower gray level values may be alternately arranged in one frame. The present invention is not limited to such an arrangement of sub-fields. What matters is that the magnitude of the reset pulses applied to the scan electrodes in the reset periods of the high gray level sub-fields among the sub-fields comprised in the frame must be less than the magnitude of the reset pulses applied to the scan electrodes in the reset periods of the remaining sub-fields regardless of how the sub-fields are arranged in the frame.

### Third Embodiment

As described above, the magnitude of the reset pulses applied to the scan electrodes in the reset periods of the sub-fields comprised in one frame is controlled in the low gray level sub-fields or in the high gray level sub-fields. However, unlike the above, the reset pulses of the sub-fields comprised in one frame may be determined to have three or more different voltage values. Such a driving method will be described with reference to the third embodiment of the method of driving the plasma display apparatus for applying the reset pulses according to the present invention.

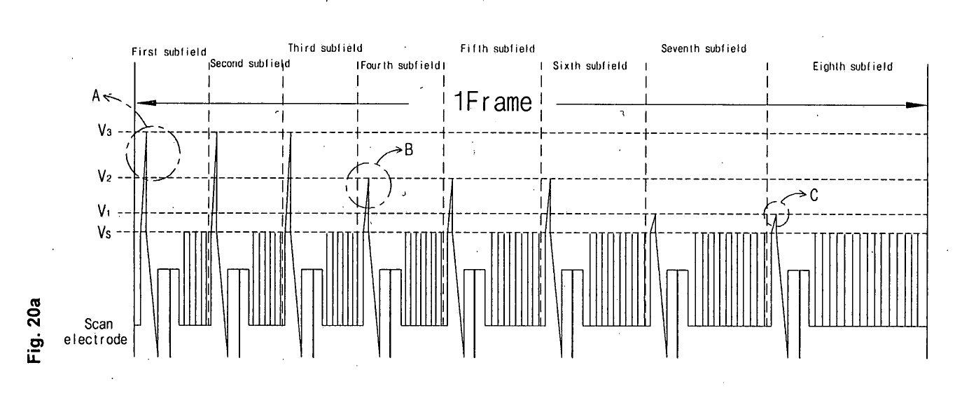

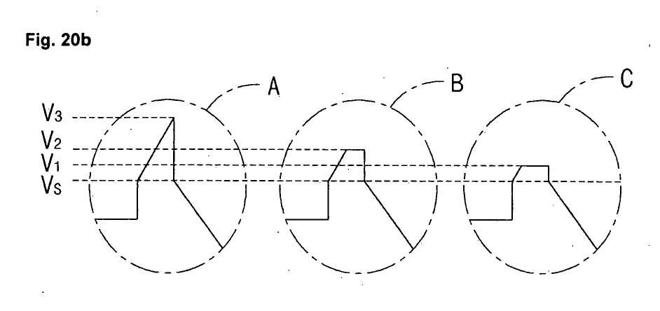

FIGS. 20A and 20B illustrate the third embodiment of the method of driving the plasma display apparatus for applying the reset pulses according to the present invention.

As illustrated in FIGS. 20A and 20B, according to the third embodiment of the method of driving the plasma display apparatus comprising scan electrodes, sustain electrodes, and a plurality of address electrodes that intersect the scan electrodes and the sustain electrodes, the magnitude of the reset pulse applied to the scan electrodes in the reset period of at least one sub-field among the sub-fields of one frame is controlled in accordance with the value of a gray level.

For example, when one frame comprises eight sub-fields as illustrated in FIG. 20A, the magnitudes of reset pulses are controlled in one frame comprising the eight sub-fields in accordance with the magnitudes of the brightness weight values of the corresponding sub-fields, that is, the magnitudes of the gray level values.

When the magnitude of the reset pulses applied to the scan electrodes in the reset periods of the sub-field that comes last to realize the highest gray level, that is, the eighth sub-field and the seventh sub-field that realizes the second highest gray level in the order where the sub-field that has the highest brightness weight value comes first is V1, that the magnitude of the reset pulses applied to the scan electrodes in the reset periods of the sub-field that comes first to realize the lowest gray level, that is, the first sub-field, the second sub-field, and the third sub-field in the order where the sub-field that has the lowest brightness weight value comes first is V3, and that the magnitude of the reset pulses applied to the scan electrodes in the reset periods of the fourth, fifth, and sixth sub-fields that have the intermediate brightness weight values, that is, gray level values between the gray level values of the seventh and eighth sub-fields and the gray level values of the first, second, and third sub-fields is V2, a relationship of V1<V2<V3 is established.

The magnitude V1 of the reset pulses applied to the scan pulses in the reset periods in the high gray level sub-fields is preferably more than the sustain voltage Vs and less than twice the sustain voltage Vs, that is, 2Vs. Therefore, a relationship of Vs<V1<2Vs is preferably established.

As described above, the sub-fields in which the magnitudes of the voltages of the reset pulses are more than the sustain voltage Vs and less than twice the sustain voltage Vs may be determined in accordance with the number of sustain pulses supplied in the sustain periods of the sub-fields of the frame. For example, a number of sustain pulses that is equal to or more than ½ of the total number of sustain pulses of the sub-fields in which the highest number of sustain pulses are supplied in the sustain periods among the sub-fields of the frame are preferably supplied to the high gray level sub-fields.

The sub-field in which the number of sustain pulses is equal to or more than 20% of the total number of the sustain pulses of one frame are supplied may be determined as the high gray level sub-field.

As described above, the reason why the magnitude of the reset pulses in the high gray level sub-fields among the sub-fields of one frame is smaller than the magnitude of the reset pulses in the remaining sub-fields, is because the address discharge is stable in the high gray level sub-fields and the high gray level sub-fields have a higher number of sustain pulses so that discharge is stable in all of the high gray level sub-fields. That is, since the discharge is stable in all of the high gray level sub-fields, although the magnitude of the voltages of the reset pulses in the reset periods is low, it is possible to uniformly distribute wall charges in the discharge cells in the entire PDP. Therefore, the magnitude of the voltages of the reset pulses applied to the scan electrodes in the reset periods in the high gray level sub-fields is made small so that it is possible to uniformly distribute the wall charges in the discharge cells and to reduce the amount of light generated by dark discharge to improve the contrast characteristic.

The magnitude V3 of the reset pulses applied to the scan electrodes in the reset periods of the low gray level sub-fields is preferably more than twice the sustain voltage, that is, 2Vs. Here, the reason why the magnitude of the reset pulses applied to the scan electrodes in the reset periods of the low gray level sub-fields is more than the magnitude of the reset pulses applied to the scan electrodes in the reset periods of the remaining sub-fields is because it is more probable that an address discharge will become unstable in the low gray level sub-fields that have lower brightness weight values than in the sub-fields that have higher brightness weight values so that the magnitude of the reset pulses applied to the scan electrodes in the reset periods of the low gray level sub-fields is more than the magnitude of the reset pulses applied to the scan electrodes in the reset periods of the remaining sub-fields to stabilize the address discharge and the sustain discharge. Since the reason why the magnitude of the reset pulses in the low gray level sub-fields is more than the magnitude of the reset pulses in the remaining sub-fields was described in detail with reference to the first or second embodiment of the method of driving the plasma display apparatus for applying the reset pulses according to the present invention, detailed description thereof will be omitted.

As described above, the sub-fields in which the magnitudes of the reset pulses are more than twice the sustain voltage Vs, that is, 2Vs may be determined in terms of the number of sustain pulses in one frame. For example, a number of sustain pulses that is equal to or less than ½ of the total number of sustain pulses of the sub-field in which the highest number of sustain pulses are supplied in the sustain period among the sub-fields of the frame are preferably supplied to the sub-fields in which the magnitude of the reset pulses is more than twice the sustain voltage Vs. Or a number of sustain pulses that is equal to or less than 20% of the total number of the sustain pulses of one frame are preferably supplied to the sub-fields in which the magnitude of the reset pulses is more than twice the sustain voltage Vs.

As described above, since the method of determining the sub-fields in which the magnitude of the reset pulses is more than twice the sustain voltage Vs was described with reference to the first or second embodiment of the method of driving the plasma display apparatus for applying the reset pulses according to the present invention, detailed description thereof will be omitted.

The reset pulses of FIG. 20A whose magnitudes are controlled in accordance with the gray level values of the sub-fields will be described with reference to FIG. 20B.

Referring to FIG. 20B, the reset pulses in one frame comprising eight sub-fields have three or more different voltage values. That is, the number of voltage values of the reset pulses that the sub-fields have in one frame is three or more. The reset pulses preferably become smaller as the magnitude of the brightness weight values, that is, the gray level values of the sub-fields in one frame decreases. For example, the reset pulses in the third and fourth sub-fields have different voltage values in the order where the magnitudes of the brightness weight values, that is, the gray level values increase in one frame, the magnitude of the reset pulse in the sub-field that has the lower brightness weight value, that is, the lower gray level value between the third and fourth sub-fields, that is, the third sub-field is higher than the magnitude of the reset pulse in the fourth sub-field.

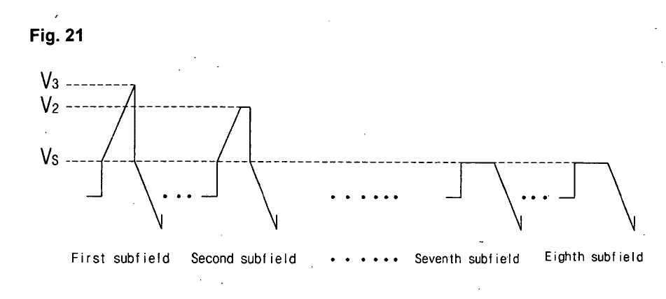

As described above, in all of the sub-fields of one frame, the reset pulses comprise the rising ramps Ramp-up that rise with a predetermined slope. However, the reset pulses may be applied so that the rising ramp is not comprised in the reset period of at least one sub-field among the sub-fields of the frame. Such a driving waveform will be described with reference to FIG. 21.

FIG. 21 illustrates another driving waveform according to the third embodiment of the method of driving the plasma display apparatus for applying the reset pulses according to the present invention.

As illustrated in FIG. 21, in another driving waveform according to the third embodiment of the method of driving the plasma display apparatus for applying the reset pulses according to the present invention, the rising ramp Ramp-up that rises with a predetermined slope is omitted from the reset pulse applied to the scan electrodes in the reset period of at least one sub-field among the sub-fields of one frame. For example, as illustrated in FIG. 21, the reset pulses in the seventh and eighth sub-fields have a waveform of a falling ramp Ramp-down that falls with a predetermined slope after maintaining a predetermined positive voltage. The rising ramps are omitted from the reset pulses of the seventh and eighth sub-fields compared with the reset pulses applied to the scan electrodes in the reset periods of the remaining sub-fields, that is, the first to sixth sub-fields. In the period where the rising ramps are applied in the remaining sub-fields, the predetermined positive voltage, for example, the sustain voltage Vs is maintained in the seventh and eighth sub-fields and then, the waveform of the falling ramp is shown. The magnitude of the positive voltage is preferably equal to the magnitude of the sustain voltage Vs. That is, in at least one sub-field of one frame, the reset pulse has a waveform that falls with a slope after maintaining the sustain voltage Vs. The sub-field from which the rising ramp is omitted is preferably a sub-field that has a higher brightness weight value, that is, a higher gray level value in one frame. Also, one or a plurality of such sub-fields may be comprise in one frame.

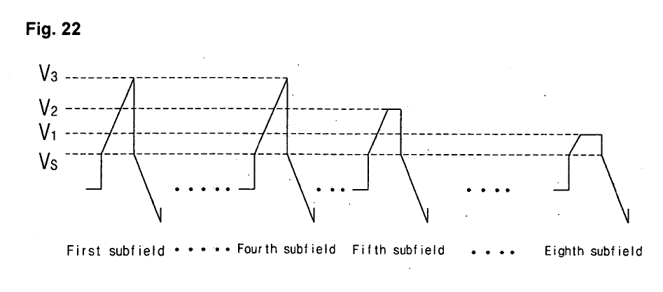

When the sub-fields in which the magnitude of the reset pulses is higher than the magnitude of the reset pulses in the remaining sub-fields are determined in one frame as illustrated in FIG. 20A, the magnitude of the reset pulses in the sub-fields having sustain pulses of equal to or more than a predetermined number based on the number of sustain pulses comprised in one frame is determined as V3. However, the sub-fields in which the magnitude of the reset pulses is V3 may be determined based on the order in which the sub-field having the lowest number of sustain pulses comes first in one frame. Such a method will be described with reference to FIG. 22.

FIG. 22 illustrates an example of the method of determining the low gray level sub-fields according to the third embodiment of the method of driving the plasma display apparatus for applying the reset pulses according to the present invention.

As illustrated in FIG. 22, a plurality of sub-fields are determined as the low gray level sub-fields in one frame so that the sub-fields from the sub-field having the lowest number of sustain pulses to the sub-field that comes fourth in the order where the sub-field having the lowest number of sustain pulses comes first are determined as the low gray level sub-fields. For example, as illustrated in FIG. 22, the first sub-field that has the lowest brightness weight value, the second sub-field, the third sub-field, and the fourth sub-field in the order where the sub-field having the lowest brightness weight value comes first are determined as the low gray level sub-fields. The magnitude of the reset pulses of the low gray level sub-fields, that is, the first, second, third, and fourth sub-fields is determined as V3. Since the method of determining the low gray level sub-fields was described in detail with reference to FIG. 13, detailed description thereof will be omitted.

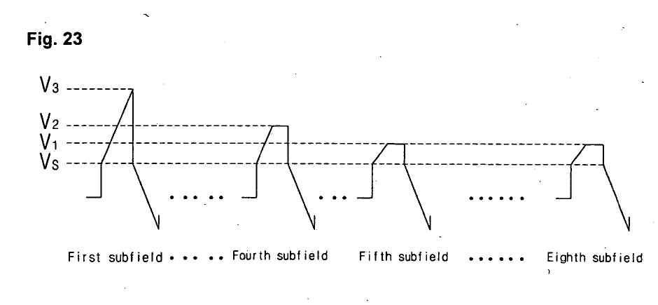

When the high gray level sub-fields in which the magnitude of the reset pulses is less than the magnitude of the reset pulses in the remaining sub-fields in one frame are determined as illustrated in FIG. 20A, the magnitude of the reset pulses in the sub-fields having sustain pulses of equal to or more than a predetermined number based on the number of sustain pulses comprised in one frame is determined as V1. However, the sub-fields in which the magnitude of the reset pulses is V1 may be determined based on the order in which the sub-fields having the highest number of sustain pulses comes first in one frame. Such a method will be described with reference to FIG. 23.

FIG. 23 illustrates an example of the method of determining the high gray level sub-fields according to the third embodiment of the method of driving the plasma display apparatus for applying the reset pulses according to the present invention.

As illustrated in FIG. 23, a plurality of sub-fields are determined as the high gray level sub-fields in one frame so that the sub-fields from the sub-field having the highest number of sustain pulses to the sub-field that comes fourth in the order where the sub-field having the highest number of sustain pulses comes first are determined as the high gray level sub-fields among the plurality of sub-fields in one frame. For example, as illustrated in FIG. 23, the eighth sub-field that has the highest brightness weight value, the seventh sub-field, the sixth sub-field, and the fifth sub-field in the order where the sub-field having the highest brightness weight value comes first are determined as the high gray level sub-fields. The magnitude of the reset pulses of the high gray level sub-fields, that is, the fifth, sixth, seventh, and eighth sub-fields is determined as V1. Since the method of determining the high gray level sub-fields was described in detail with reference to FIG. 17, detailed description thereof will be omitted.

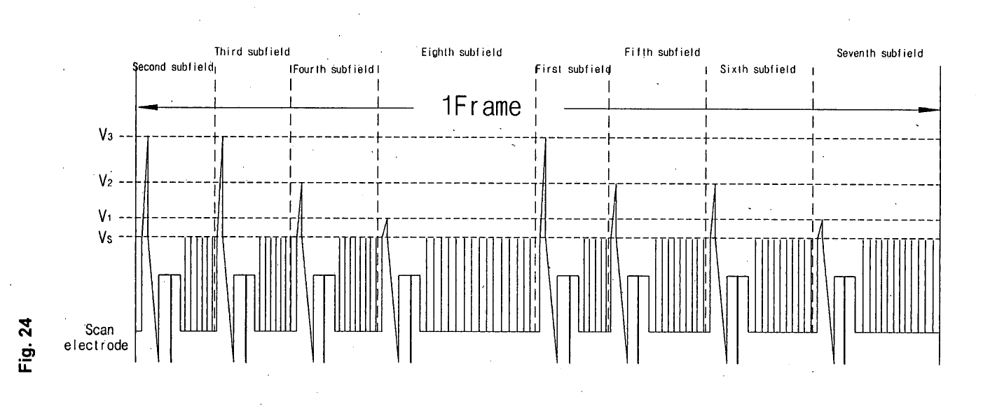

According to the third embodiment of the method of driving the plasma display apparatus for applying the reset pulses according to the present invention, only one example in which the sub-fields comprised in one frame are regularly arranged in the order of the magnitudes of the brightness weight values, that is, the magnitudes of the gray level values has been described. However, unlike the above, the sub-fields may be irregularly arranged in one frame. One example of such a driving method will be described with reference to FIG. 24.

FIG. 24 illustrates the arrangement of the sub-fields in one frame according to the third embodiment of the method of driving the plasma display apparatus for applying the reset pulses according to the present invention.

As illustrated in FIG. 24, the sub-fields in one frame are not regularly arranged in the order of the magnitudes of the brightness weight values, that is, the magnitude of the gray level value but are randomly arranged regardless of the magnitude of the gray level value. That is, when the sub-fields are arranged in the order of the first, second, third, fourth, fifth, sixth, seventh, and eighth sub-fields in FIG. 20(16)A, the sub-fields are arranged in the order of the second, third, fourth, eighth, first, fifth, sixth and seventh sub-fields in FIG. 24. In the frame where the sub-fields are irregularly arranged as described above, when the magnitude of the reset pulses applied to the scan electrodes in the reset periods of the low gray level sub-fields that have lower brightness weight values, that is, the first, second, and third sub-fields is V3, that the magnitude of the reset pulses supplied to the scan electrodes in the reset periods of the sub-fields that come fourth and eighth that are the high gray level sub-fields that have higher brightness weight values, among the sub-fields of the frame, that is, the seventh and eighth sub-fields is V1, and that the magnitude of the reset pulses supplied to the scan electrodes in the reset periods of the remaining gray level sub-fields excluding the low gray level sub-fields and the high gray level sub-fields, which come third, sixth, and seventh, that is, the fourth, fifth, and sixth sub-fields is V2, a relationship of V1<V2<V3 is established.

The magnitudes of the reset pulses supplied in the reset periods of the sub-fields in one frame may also vary. For example, when one frame comprises eight sub-fields, the magnitude of the reset pulse of the first sub-field is V1, the magnitude of the reset pulse of the second sub-field is V2, the magnitude of the reset pulse of the third sub-field is V3, the magnitude of the reset pulse of the fourth sub-field is V4, the magnitude of the reset pulse of the fifth sub-field is V5, the magnitude of the reset pulse of the sixth sub-field is V6, the magnitude of the reset pulse of the seventh sub-field is V7, and the magnitude of the reset pulse of the eighth sub-field is V8. V1 to V8 have different values.

As described above, according to the third embodiment of the method of driving the plasma display apparatus for applying the reset pulses according to the present invention, in at least one high gray level sub-field that has a higher brightness weight value in one frame, the magnitude of the reset pulse is less than the magnitude of the reset pulses in the remaining sub-fields. In at least one low gray level sub-field that has a lower brightness weight value, the magnitude of the reset pulse is more than the magnitude of the reset pulses in the remaining sub-fields. In the sub-fields that realize the intermediate gray levels between the high gray level sub-field and the low gray level sub-field, the magnitude of the reset pulses is more than the magnitude of the reset pulse in the high gray level sub-field and less than the magnitude of the reset pulse in the low gray level sub-field. Therefore, in the low gray level sub-field where it is more likely that the address discharge will become unstable, a reset discharge is stabilized by the reset pulse whose magnitude is higher to stabilize the address discharge. In the high gray level sub-field where the address discharge is stable compared with the low gray level sub-field, the generation of the unnecessary light that does not contribute to display of an image, which is caused by dark discharge, is prevented by the reset pulse whose magnitude is lower to improve contrast. According to the third embodiment of the method of driving the plasma display apparatus for applying the reset pulses according to the present invention, the sub-fields of one frame are not divided into high gray level sub-fields and low gray level sub-fields but comprise reset pulses of three or more different magnitudes so that the reset pulse of the optimal magnitude can be applied in each sub-field in accordance with the brightness weight value, that is, the gray level value of the sub-field. Therefore, it is possible to improve the driving margin and to prevent contrast from deteriorating.

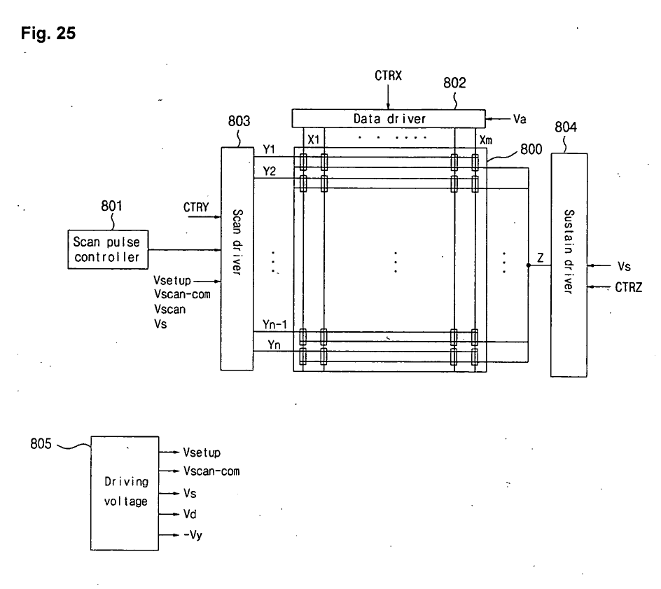

FIG. 25 illustrates the structure of a plasma display apparatus for applying scan pulses according to the present invention. As illustrated in FIG. 25, the plasma display apparatus according to the present invention comprises a PDP 800 comprising the scan electrodes Y1 to Yn and the sustain electrodes Z and the plurality of address electrodes X1 to Xm that intersect the scan electrodes Y1 to Yn and the sustain electrodes Z to display an image composed of a frame by combination of at least one sub-fields in which driving pulses are applied to the address electrodes X1 to Xm, the scan electrodes Y1 to Yn, and the sustain electrodes Z in the reset periods, the address periods, and the sustain periods, a data driver 802 for supplying data to the address electrodes X1 to Xm formed in the PDP 800, a scan driver 803 for driving the scan electrodes Y1 to Yn, a sustain driver 804 for driving the sustain electrodes Z that are common electrodes, a scan pulse controller 801 for controlling the scan driver 803 when the PDP 800 is driven, and a driving voltage generator 805 for supplying required driving voltages to the drivers 802, 803 and 804.

The plasma display apparatus according to the present invention displays an image composed of a frame by combination of at least one sub-fields in which driving pulses are applied to the address electrodes, the scan electrodes, and the sustain electrodes in the reset periods, the address periods, and the sustain periods. The frame is divided into a plurality of sub-field groups so that the drivers 802, 803, and 804 are controlled in the plurality of sub-field groups. The width of the scan pulses applied to one or more scan electrode groups among the plurality of scan electrode groups comprising one or more scan electrodes arranged in the order of scanning in one or more sub-fields of the frame is different from the width of the scan pulses applied to the remaining scan electrode groups. The reason why the widths of the scan pulses are controlled as described above will be described in detail hereinafter. Also, the meaning of the scan electrode groups will be described in detail with reference to the method of driving the plasma display apparatus.

The PDP 800 comprises a top surface panel (not shown) and a bottom surface panel (not shown) combined with each other so that the top surface panel and the bottom surface panel are separated from each other by a predetermined distance. In the top surface panel, a plurality of electrodes, for example, the scan electrodes Y1 to Yn and the sustain electrodes Z are formed to make pairs. In the bottom surface panel, the address electrodes X1 to Xm are formed to intersect the scan electrodes Y1 to Yn and the sustain electrodes Z.

Data that are inverse gamma corrected and error diffused by an inverse gamma correcting circuit and an error diffusing circuit that are not shown and then, are mapped by a sub-field mapping circuit in the sub-fields are supplied to the data driver 802. The data driver 802 samples and latches the data in response to data timing control signals CTRX from a timing controller (not shown) and then, supplies the data to the address electrodes X1 to Xm.

The scan driver 803 supplies a rising ramp waveform Ramp-up and a falling ramp waveform Ramp-down to the scan electrodes Y1 to Yn under the control of the scan pulse controller 801 in the reset period. Also, the scan driving part 803 sequentially supplies scan pulses Sp of a scan voltage −Vy to the scan electrodes Y1 to Yn in the address period and supplies sustain pulses sus to the scan electrodes Y1 to Yn in the sustain period under the control of the scan pulse controller 801.

The sustain driver 804 supplies the bias voltage of a sustain voltage Vs to the sustain electrodes Z under the control of the timing controller (not shown) in a period where the falling ramp waveform Ramp-down is generated and in the address period and alternates the scan driver 803 in the sustain period to supply the sustain pulses sus to the sustain electrodes Z.

The scan pulse controller 801 generates predetermined timing control signals CTRY for controlling the operating timing and synchronization of the scan driver 803 in the reset period, the address period, and the sustain period and supplies the timing control signals CTRY to the scan driver 803 to control the scan driver 803. In particular, the scan pulse controller 801 controls the scan driver 803 in one or more sub-fields of one frame so that the width of the scan pulses applied to one or more scan electrode groups among the plurality of scan electrode groups comprising one or more scan electrodes arranged in the order of scanning is different from the width of the scan electrodes applied to the remaining scan electrode groups.

The data control signals CTRX comprise a sampling clock for sampling data, a latch control signal, and a switch control signal for controlling the on/off times of an energy frequency circuit and a driving switch device. A scan control signal CTRY comprises a switch control signal for controlling the on/off times of the energy frequency circuit and the driving switch device in the scan driver 803. A sustain control signal CTRZ comprises a switch control signal for controlling the on/off times of the energy frequency circuit and the driving switch device in the sustain driver 804.

The driving voltage generator 805 generates a set-up voltage Vsetup, a scan common voltage Vscan-com, the scan voltage −Vy, the sustain voltage Vs, and a data voltage Vd. The driving voltages may vary in accordance with the composition of discharge gas or the structure of a discharge cell.

Although not shown, the structure of the plasma display apparatus according to the present invention is the same as the structure of the plasma display apparatus according to the present invention of FIG. 25 excluding that the scan pulse controller 801 applies predetermined control signals to the scan driver 803 to control the widths of the scan pulses applied to the scan electrodes in one or more sub-fields of one frame in accordance with an average picture level (APL) as well as generates predetermined control signals for controlling the operation timing and synchronization of the scan driver 803 in the address period and supplies the timing control signals to the scan driver 803 to control the scan driver 803.

The function of another plasma display apparatus according to the present invention of such a structure will be described in detail with reference to the method of driving the plasma display apparatus.

Various embodiments of the method of driving the plasma display apparatus having such a structure will be described as follows.

### Fourth Embodiment

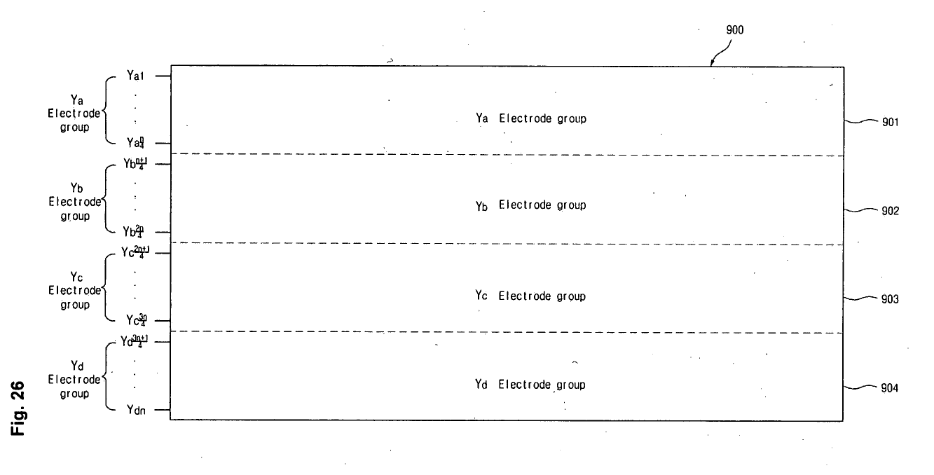

According to the fourth embodiment of the method of driving the plasma display apparatus for applying scan pulses according to the present invention, the scan electrodes on a PDP are divided into a plurality of scan electrode groups so that, in at least one scan electrode group among the divided scan electrode groups, the width of the scan pulses applied to the scan electrodes in an address period is different from the width of the scan pulses applied to the remaining scan electrode groups. Therefore, an example of a method of dividing the scan electrodes into a plurality of scan electrode groups will be described with reference to FIG. 26.

FIG. 26 illustrates that the scan electrodes Y1 to Yn formed in the PDP are divided into four scan electrode groups to describe the method of driving the plasma display apparatus for applying the scan pulses according to the present invention.

As illustrated in FIG. 26, the scan electrodes Y1 to Yn of a PDP 900 are divided into, for example, a Ya electrode group Ya1 to Ya(n)/4 901, a Yb electrode group Yb(n+1)/4 to Yb(2n)/4 902, a Yc electrode group Yc(2n+1)/4 to Yc(3n)/4 903, and a Yd electrode group Yd(3n+1)/4 to Yd(n) 904. The number N of scan electrode groups is set to 2≦N≦(n−1)when the total number of scan electrodes is n.

All of the scan electrodes comprised in one scan electrode group are continuously scanned. That is, scan electrodes of a predetermined number are set as a scan electrode group based on the order of scanning. For example, in FIG. 26, the scan electrode group Ya comprises the scan electrodes Ya1 to Ya(n/4) and the scan electrode group Yb comprises the scan electrodes Yb((n+1)/4) to Yb(2n/4). The scan electrode Ya1 of the scan electrode group Ya is first scanned and the scan electrode Ya2 is scanned next so that scanning is performed in the order of Ya3 . . . Ya((n−1)/4), Ya(n/4), Yb((n+1)/4) Yb((2n−1)/4), and Yb(2n/4).

In FIG. 26, the number of scan electrodes comprised in each of the scan electrode groups 901, 902, 903 and 904 is the same. However, the number of scan electrodes comprised in each of the scan electrode groups 901, 902, 903 and 904 may vary. The number of scan electrode groups may be controlled. An example in which the number of scan electrodes comprised in each of the scan electrodes varies or the number of scan electrode groups is controlled will be described in detail hereinafter.

A fourth embodiment of the method of driving the plasma display apparatus in which the scan electrodes of the plasma display panel are divided into a plurality of scan electrode groups, for example, four scan electrode groups as illustrated in FIG. 26 will be described as follows.

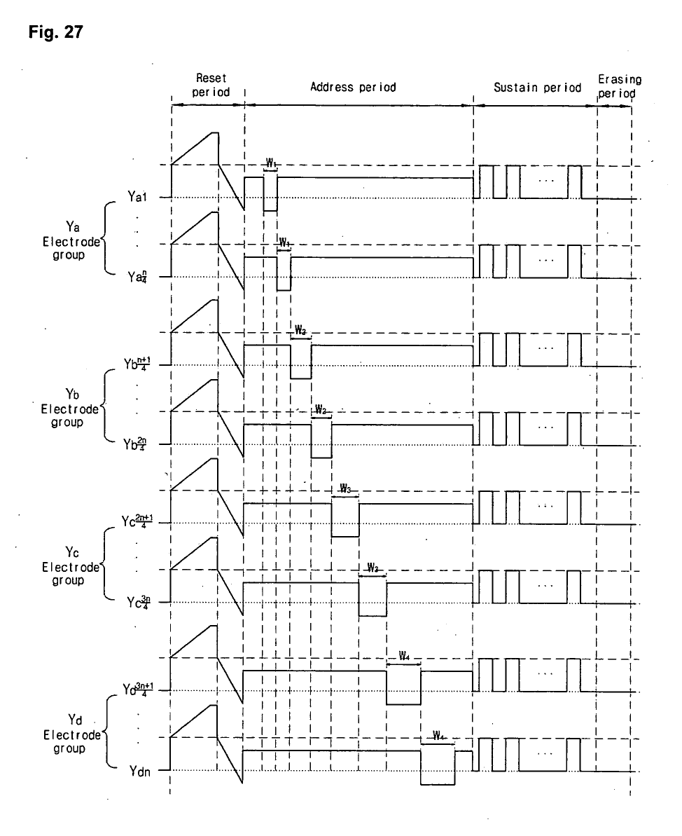

FIG. 27 illustrates the fourth embodiment of the method of driving the plasma display apparatus for applying the scan pulses according to the present invention.

As illustrated in FIG. 27, according to the fourth embodiment of the method of driving the plasma display apparatus for applying the scan pulses according to the present invention, when the scan electrodes Y1 to Yn are divided into the four scan electrode groups, that is, the scan electrode group Ya, the scan electrode group Yb, the scan electrode group Yc, and the scan electrode group Yd as illustrated in FIG. 26, the width of the scan pulses applied to the scan electrodes is controlled in the order of scanning in one or more scan electrode groups among the four scan electrode groups. That is, the width of the scan pulses applied to the scan electrodes in one or more scan electrode groups among the four scan electrode groups is made different from the width of the scan pulses applied to the scan electrodes in the remaining scan electrode groups.

For example, when the scan electrodes are arranged in the order of FIG. 26 on the PDP and that the scan pulses are sequentially applied in the order of arrangement of FIG. 26, in FIG. 27, the width of the scan pulses applied to the scan electrode group Ya comprising the scan electrodes Y1 to Ya1 that are scanned earlier, that is, the width of the scan pulses applied to the scan pulses Y1 to Ya(n/4) is W1, which is narrowest.

The width of the scan pulses applied to the scan electrode group Yb comprising the scan electrodes Yb((n+1)/4) to Yb((2n)/4) that are scanned later than the scan electrodes comprised in the scan electrode group Ya, that is, the width of the scan pulses applied to the scan electrodes Yb((n+1)/4) to Yb((2n)/4) is W2, which is more than W1. The width of the scan pulses applied to the electrode group Yc is W3, which is more than W2 and the width of the scan pulses applied to the electrode group Yd is W4, which is more than W3. That is, a relationship of W1<W2<W3<W4 is established among the magnitudes of the scan pulses.

The reason why the scan pulses whose width is narrower are applied to the scan electrode group that is scanned earlier and the scan pulses whose width is wider are applied to the scan electrode group that is scanned later as described above is as follows.

Being scanned earlier means that the address discharge is generated within a short time after the reset discharge generated in the reset period. Also, immediately after the reset discharge, a plurality of priming particles generated by the reset discharge exist in a discharge cell. Therefore, a strong enough address discharge is generated even if the scan pulses having a narrower width are applied to the scan electrodes that are scanned earlier.

Being scanned later means that the address discharge is generated in a substantial time after the reset discharge generated in the reset period. The number of priming particles is reduced in the discharge cell with a lapse of time. Therefore, the scan pulses having a wider width are applied to the scan electrodes that are scanned later so that the address discharge is generated in a substantial time after the reset discharge so that it is possible to prevent the address discharge from becoming weak or from not being generated due to a lack in the number of priming particles that exist in the discharge cell.

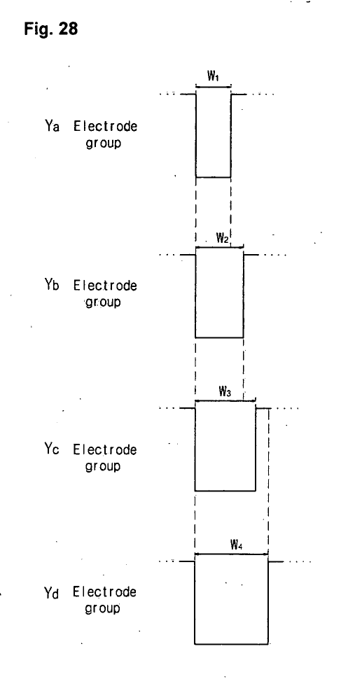

The scan pulses whose widths are controlled in the order of scanning will be described in detail with reference to FIG. 28.

FIG. 28 illustrates the widths of the scan pulses controlled in the order of scanning. As illustrated in FIG. 28, the width W1 of the scan pulses applied to the scan electrode group Ya comprising the scan electrodes that are scanned first is narrowest and the width of the scan pulses applied to the scan electrode group Yb that is scanned later than the scan electrode group Ya is set as W2 and is wider than W1. The widths of the scan pulses applied to the scan electrode group Yc and the scan electrode group Yd are determined. The width of the scan pulses may be the same or may vary.

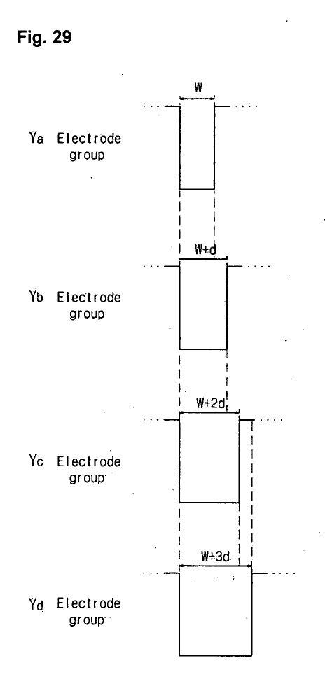

FIG. 29 illustrates an the example of difference in width between the scan pulses according to the fourth embodiment of the method of driving the plasma display apparatus for applying the scan pulses according to the present invention.

As illustrated in FIG. 29, the difference in width between any two scan pulses that are used for scanning of any two continuous scan electrode groups is the same as the difference in width between other two scan pulses that are used for scanning of other two continuous scan electrode groups. For example, when it is assumed that the width of the scan pulses applied to the scan electrode group Ya is W, the width of the scan pulses applied to the scan electrode group Yb is W+d, the width of the scan pulses applied to the scan electrode group Yc is W+2d, and the width of the scan pulses applied to the scan electrode group Yd is W+3d. That is, the difference(d) in width between any two scan pulses that are used for scanning of continuous scan electrode groups is the same as the difference in width between other two scan pulses that are used for scanning of continuous scan electrode groups.

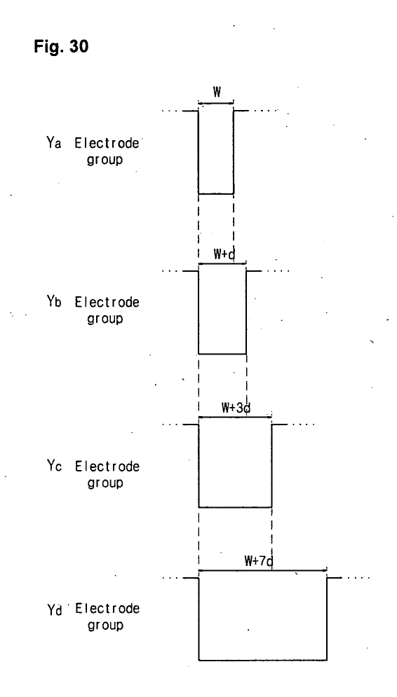

FIG. 30 illustrates another example of difference in width between the scan pulses according to the fourth embodiment of the method of driving the plasma display apparatus for applying the scan pulses according to the present invention.

As illustrated in FIG. 30, a difference in width between any two scan pulses that are used for scanning, of any two continuous scan electrode groups can be different from the difference in width between other two scan pulses that are used for scanning of other two continuous scan electrode groups. For example, when the width of the scan pulses applied to the scan electrode group Ya is W, the width of the scan pulses applied to the scan electrode group Yb is W+b, the width of the scan pulses applied to the scan electrode group Yc is W+3d, and the width of the scan pulses applied to the scan electrode group Yd is W+7d. That is, the difference in width between any two scan pulses that are used for scanning of two continuous scan electrode groups is d, 2d or 4d.

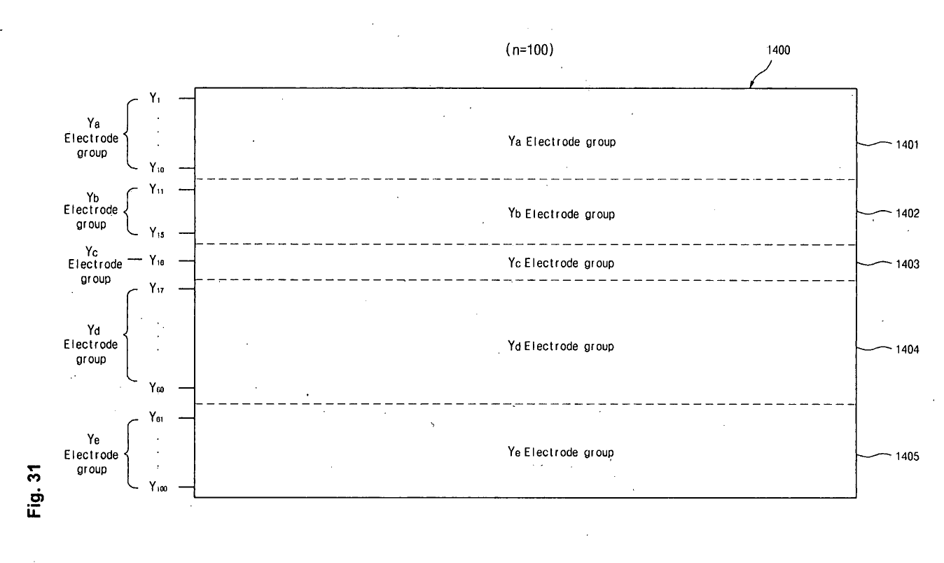

The number of scan electrodes in one or more scan electrode groups among the plurality of scan electrode groups may be different from the numbers of scan electrodes comprised in the remaining scan electrode groups. An example in which the scan electrode groups are divided as described above will be described with reference to FIG. 31.

FIG. 31 illustrates an example in which the scan electrodes formed on the PDP are divided into scan electrode groups in which one or more scan electrode groups comprise different numbers of scan electrodes.

As illustrated in FIG. 31, when the total number of scan electrodes of a PDP 1400 is 100, the scan electrodes Y1 to Y100 are divided into the scan electrode group Ya (Y1 to Y10) 1401, the scan electrode group Yb (Y11 to Y15) 1402, the scan electrode group Yc (Y16) 1403, the scan electrode group Yd (Y17 to Y60) 1404, and the scan electrode group Ye (Y61 to Y100) 1405. As described above, the scan electrode groups comprise different numbers of scan electrodes.

The scan electrode group Yc comprises only one scan electrode, that is, the scan electrode Y16 unlike the remaining scan electrode groups.

Excluding the case in which one scan electrode group comprises one scan electrode as described above, all of the scan electrodes comprised in one scan electrode group are continuously scanned. That is, when one scan electrode group comprises a plurality of scan electrodes, for example, the scan electrodes Y1, Y2, and Y3, the scan electrodes Y1, Y2, and Y3 are continuously scanned in the scan electrode group.

When one scan electrode group comprises a plurality of scan electrodes, all of the scan electrodes comprised in the scan electrode group are continuously scanned as illustrated in FIG. 26. That is, scan electrodes of a predetermined number are set as one scan electrode group based on the order of scanning.

The respective scan electrode groups comprise different numbers of scan electrodes. Only scan electrode groups of a predetermined number selected from the plurality of scan electrode groups may comprise scan electrodes of different numbers from the numbers of scan electrodes comprised in the remaining scan electrode groups. For example, in FIG. 31, the scan electrode group Ya comprises 10 scan electrodes that are continuously scanned, the scan electrode group Yb comprises 5 scan electrodes that are continuously scanned, the scan electrode group Yc comprises one scan electrode, the scan electrode group Yd comprises 44 scan electrodes that are continuously scanned, and the scan electrode group Ye comprises 40 scan electrodes that are continuously scanned.

In the scan electrode groups divided as described above, the widths of the scan pulses are also controlled in the order of scanning as illustrated in FIG. 27. Since the method of controlling the widths of the scan electrodes in the scan electrode groups was described in detail with reference to FIG. 27, detailed description thereof will be omitted.

As described above, the scan pulses of narrower widths are applied to the scan electrode groups that are scanned earlier and the scan pulses of wider widths are applied to the scan electrode groups that are scanned later so that it is possible to prevent the length of the entire address period in one sub-field from increasing and to prevent the address discharge from becoming unstable due to a lack of priming particles in the scan electrode groups that are scanned later to stabilize the discharge of the entire PDP.

### Fifth Embodiment

According to the fourth embodiment of the method of driving the plasma display apparatus for applying the scan pulses according to the present invention, the widths of the applied scan pulses are controlled in one or more scan electrode groups in one sub-field in accordance with the order of scanning. The widths of the scan pulses of one or more sub-fields may be controlled in one frame in accordance with the screen brightness of the PDP. Such a method of driving the plasma display apparatus is the same as the fifth embodiment of the method of driving the plasma display apparatus for applying the scan pulses according to the present invention.

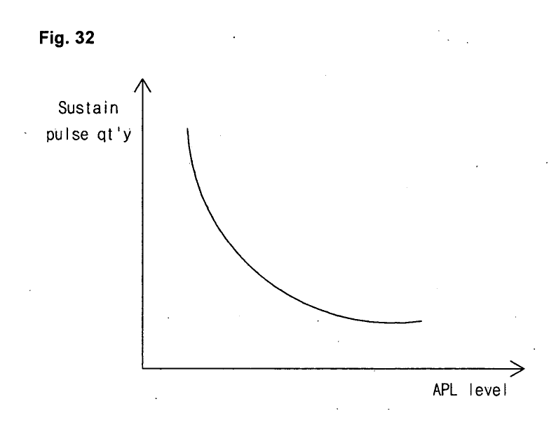

According to the fifth embodiment of the method of driving the plasma display apparatus for applying the scan pulses according to the present invention, the widths of the scan pulses in one or more sub-fields are controlled in accordance with the entire screen brightness of the PDP, that is, an average picture level (APL). To facilitate an understanding of the fifth embodiment of the method of driving the plasma display apparatus according to the present invention, the APL will be described with reference to FIG. 32.

FIG. 32 illustrates the APL. As illustrated in FIG. 32, the number of sustain pulses is reduced as the value of the APL increases and increases as the value of the APL decreases. For example, when an image is displayed only in a small area of the PDP screen, that is, when the area in which the image is displayed is small (in such a case, the APL is low), since the number of discharge cells that contribute to display of the image is low, a larger number of sustain pulses are applied to each of the discharge cells that contribute to display of the image so that the amount of power consumption of the PDP is reduced. Also, the brightness of the portion of the screen where the image is displayed increases to improve the picture quality.

When an image is displayed only in a larger area on the screen of the PDP, that is, when the area in which the image is displayed is larger (in this case, the APL is larger), since the number of discharge cells that contribute to display of the image is high, a lower number of sustain pulses are applied to each of the discharge cells that contribute to display of the image so that the amount of power consumption of the PDP decreases.

When an image is displayed in a large area on the screen of the PDP, the number of sustain pulses supplied to each of the discharge cells decreases to reduce power consumption. When an image is displayed in a small area on the screen of the PDP, the number of sustain pulses supplied to each of the discharge cells increases to compensate for a reduction in brightness to prevent the brightness realized by the entire PDP from decreasing and to reduce power consumption.

The fifth embodiment of the method of driving the plasma display apparatus for applying the scan pulses according to the present invention to which the APL is applied will be described with reference to FIG. 32.

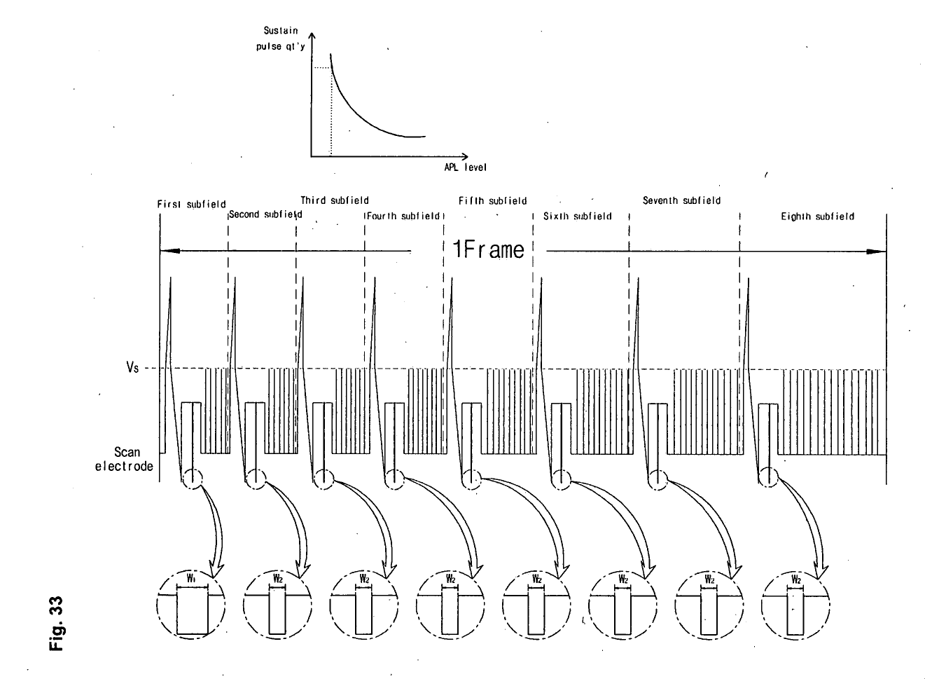

FIG. 33 illustrates the fifth embodiment of the method of driving the plasma display apparatus for applying the scan pulses according to the present invention. As illustrated in FIG. 33, according to the fifth embodiment of the method of driving the plasma display apparatus for applying the scan pulses according to the present invention, the widths of the scan pulses applied to the scan electrodes are controlled in one or more sub-fields of a frame in accordance with the APL. For example, when the APL is low as illustrated in FIG. 33, that is, when the area in which an image is displayed on the screen of the PDP is small (when the number of sustain pulses applied to one discharge cell per unit gray level is high), the width W1 of the scan pulse applied to the scan electrodes in the sub-field such as the first sub-field that has a lower brightness weight value is wider than the width W2 of the scan pulses applied to the scan electrodes in the remaining sub-fields.

For example, as illustrated in FIG. 33, when one frame comprises eight sub-fields, the width W1 of the scan pulse applied to the scan electrodes in the first sub-field among the sub-fields is wider than the width W2 of the scan pulses applied to the scan electrodes in the remaining sub-fields, that is, the second to eighth sub-fields.

As described above, the reason why the width of the scan pulses in the low gray level sub-fields that have lower brightness weight values is more than the width of the scan pulses in the remaining gray level sub-fields in one frame where the APL is lower is because the area in which the image is displayed on the screen of the PDP is smaller when the APL is lower so that the low gray level sub-fields that have lower brightness weight values are more frequently selected than the high gray level sub-fields. Therefore, the width of the scan pulses of the low gray level sub-fields that are more frequently selected when the APL is low increases so that the entire discharge of the PDP stabilizes.

In one frame comprising the sub-fields that are selected with different frequencies in accordance with difference in the APL, the width of the scan pulses increases in the sub-fields that are more frequently selected and the width of the scan pulses decreases in the sub-fields that are less frequently selected to stabilize the entire discharge of the PDP and to prevent the brightness of the PDP from decreasing due to a reduction in the number of sustain pulses, which is caused by an increase in the length of the unnecessary address period.

The widths of the scan pulses applied to the scan electrodes in the sub-fields are preferably the same.

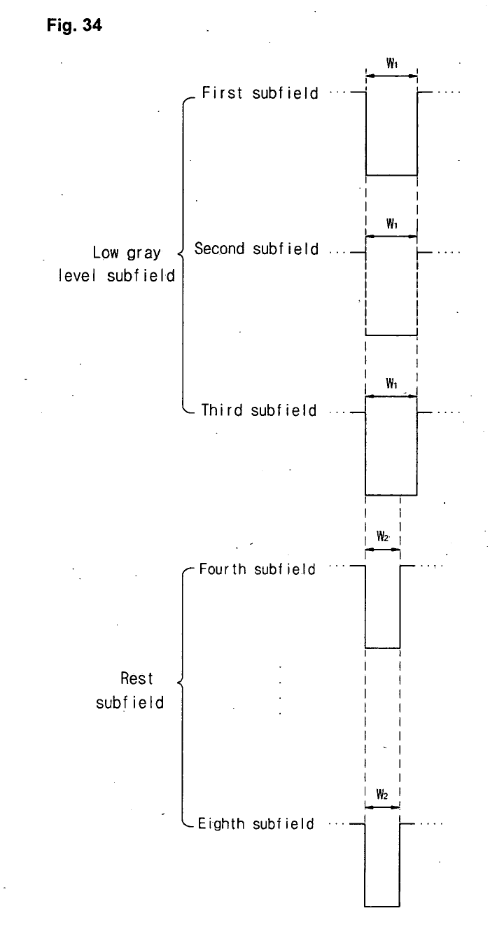

In FIG. 33, the number of low gray level sub-fields in which the width of the scan pulses is wider than the width of the scan pulses in the remaining sub-fields in one frame where the APL is lower is one. A plurality of low gray level sub-fields may be comprised in one frame. Such a method of driving the plasma display apparatus will be described with reference to FIG. 34(17).

FIG. 34 illustrates an example in which the widths of the scan pulses are controlled in accordance with the APL in a plurality of sub-fields in one frame. As illustrated in FIG. 34, the width of the scan pulses applied to the scan electrodes in the first, second, and third sub-fields in one frame is wider than the width of the scan pulses of the fourth, fifth, sixth, seventh, and eighth sub-fields. In FIG. 34, the APL is lower as illustrated in FIG. 33. As described above, the width of the scan pulses in the low gray level sub-fields that are more frequently selected when the APL is lower, that is, the first, second, and third sub-fields is wider than the width of the scan pulses in the remaining sub-fields.

The low gray level sub-fields may be determined based on the number of sustain pulses. For example, the low gray level sub-field preferably comprises a number of sustain pulses that is equal to or less than 20% of the number of sustain pulses of the sub-field comprising the highest number of sustain pulses in one frame. For example, when the total number of sustain pulses comprised in the sub-field having the largest number of sustain pulses in one frame is 1,000, the sub-field comprising 200 or less sustain pulses is determined as the low gray level sub-field. When such a rule is applied to FIG. 34, the first, second, and third sub-fields of FIG. 34 are the sub-fields each having 200 or less sustain pulses.

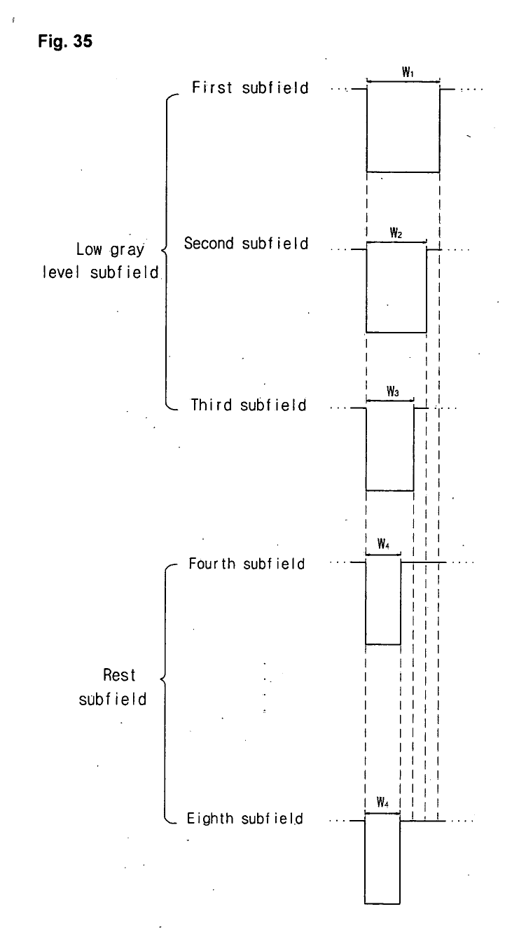

In the driving waveform of FIG. 34, the widths of the scan pulses applied to the scan electrodes in the address periods of the plurality of sub-fields determined as the low gray level sub-fields are the same. However, the widths of the scan pulses applied to the scan electrodes in the address periods of the plurality of sub-fields determined as the low gray level sub-fields may be different from each other, which will be described with reference to FIG. 35.

FIG. 35 illustrates another example in which the widths of the scan pulses are controlled in accordance with the APL in the plurality of sub-fields in one frame.

As illustrated in FIG. 35, the widths of the scan pulses applied to the scan electrodes in the first, second, and third sub-fields in one frame are wider than the widths of the scan pulses of the fourth, fifth, sixth, seventh, and eighth sub-fields. The width of the scan pulse of the first sub-field, the width of the scan pulse of the second sub-field, and the width of the scan pulse of the third sub-field are different from each other. The width of the scan pulses in the first, second, and third sub-fields are also wider than the widths of the fourth, fifth, sixth, seventh and eighth sub-field. The first, second and third sub-field are the low gray level sub-fields.

In the first, second and third sub-fields that are the low gray level sub-fields, the width W1 of the scan pulse of the first sub-field having the lowest gray level value is widest, the width W2 of the scan pulse of the second sub-field is the second widest, and the width W3 of the scan pulse of the third sub-field is narrowest. The width W4 of the scan pulses of the remaining sub-fields, that is, the fourth, fifth, sixth, seventh and eighth sub-fields is narrower than the widths W1, W2 and W3.

In FIG. 35, the widths of the scan pulses of a plurality of the low gray level sub-fields are different from each other. However, the predetermined number of low gray level sub-fields are selected from the plurality of low gray level sub-fields so that the width of the scan pulses in the selected low gray level sub-fields may be different from the widths of the scan pulses in the remaining low gray level sub-fields. For example, in FIG. 35, in the low gray level sub-fields, the width of the scan pulse of the first sub-field may be set as W1 and the width of the scan pulses of the remaining low gray level sub-fields, that is, the second and third sub-fields may be set as W2.

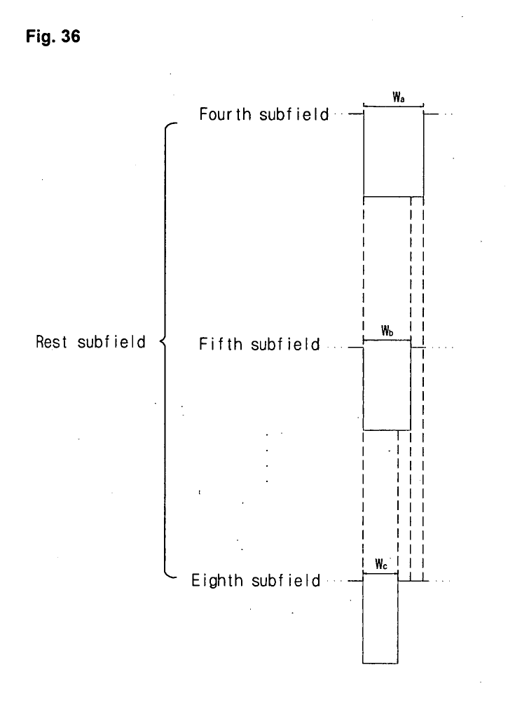

According to the fourth embodiment of the method of driving the plasma display apparatus according to the present invention, the widths of the scan pulses in the remaining sub-fields excluding the low gray level sub-fields among the sub-fields of one frame are the same and are narrower than the widths of the scan pulses in the low gray level sub-fields. However, in the remaining sub-fields excluding the low gray level sub-fields, one or more sub-fields may have scan pulses of different widths, which will be described with reference to FIG. 36.

FIG. 36 illustrates the widths of the scan pulses in the remaining sub-fields excluding the low gray level sub-fields. As illustrated in FIG. 36, in the remaining sub-fields excluding the low gray level sub-fields of one frame, one or more sub-fields have scan pulses of different widths.

For example, as illustrated in FIG. 36, in the remaining sub-fields excluding the low gray level sub-fields, the width Wa of the scan pulse of the fourth sub-field having the lowest gray level value is the widest, the width Wb of the scan pulse of the fifth sub-field is narrower than Wa, and the width Wc of the scan pulse of the eighth sub-field is narrower than Wa or Wb. The width Wa, Wb or Wc of the scan pulse is less than W1, W2 or W3 in FIG. 18.

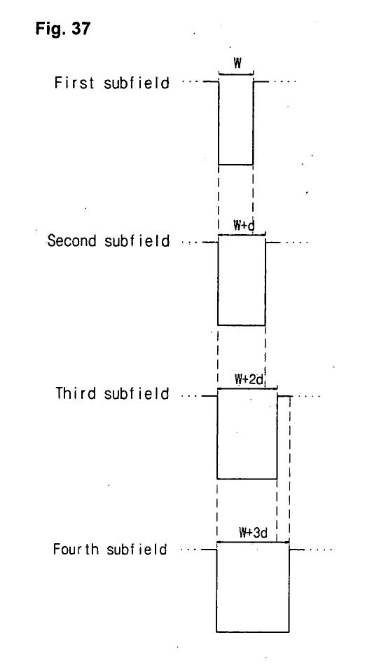

As illustrated in FIGS. 33, 34, 35, and 36, difference in width between the scan pulses having different widths in one frame may be the same or vary. The case in which the difference in width between two scan pulses from adjacent sub-fields may be the same as or different from the difference in width between 2 scan pulses from other adjacent sub-fields in a frame will be described with reference to FIG. 37.

FIG. 37 illustrates an example of the differences in width between the scan pulses according to the fifth embodiment according to the present invention.

As illustrated in FIG. 37, the difference in width between two scan pulses from adjacent sub-fields is the same as the difference in width between 2 scan pulses from other adjacent sub-fields. When the widths of the scan pulses of the low gray level sub-fields are wider than the widths of the scan pulses of the remaining sub-fields in one frame where the APL is lower, the difference in width between the two scan pulses of different widths, for example, the difference in width between the scan pulse width W1 of the first sub-field and the scan pulse width W2 of the second sub-field, the difference in width between the scan pulse width W2 of the second sub-field and the scan pulse width W3 of the third sub-field, and the difference in width between the scan pulse width W3 of the third sub-field and the scan pulse width W4 of the fourth sub-field of FIG. 35 are the same. Also, when the widths of the scan pulses are different from each other in the remaining sub-fields excluding the low gray level sub-fields of FIG. 36, the difference between Wa and Wb and the difference between Wb and Wc are the same.

To be specific, as illustrated in FIG. 37, when the width of the scan pulse applied in the first sub-field is W, the width of the scan pulse applied in the second sub-field is W+d, the width of the scan pulse applied in the third sub-field is W+2d, and the width of the scan pulse applied in the fourth sub-field is W+3d. The difference in width between the two scan pulses is d.

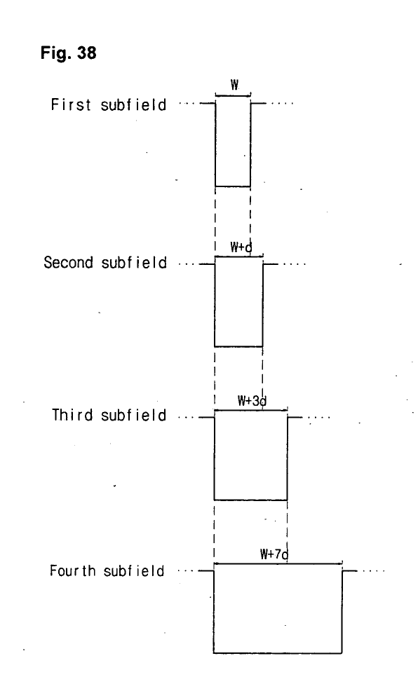

The difference in width between 2 scan pulses from adjacent subfields may be different from the differences in width between 2 scan pulses from other adjacent sub-fields in a frame. Such a driving waveform will be described with reference to FIG. 38.

FIG. 38 illustrates another example of difference in width between the scan pulses according to the fifth embodiment of the method of driving the plasma display apparatus for applying the scan pulses according to the present invention.

As illustrated in FIG. 38, the difference in width between 2 scan pulses from adjacent subfields is different from the differences in width between 2 scan pulses from other adjacent sub-fields in a frame.

For example, when the width of the scan pulse applied in the first sub-field is W, the width of the scan pulse applied in the second sub-field is W+d, the width of the scan pulse applied in the third sub-field is W+3d, and the width of the scan pulse applied in the fourth sub-field is W+7d. That is, the difference in width d, 2d or 4d between the two scan pulses of different widths is different.

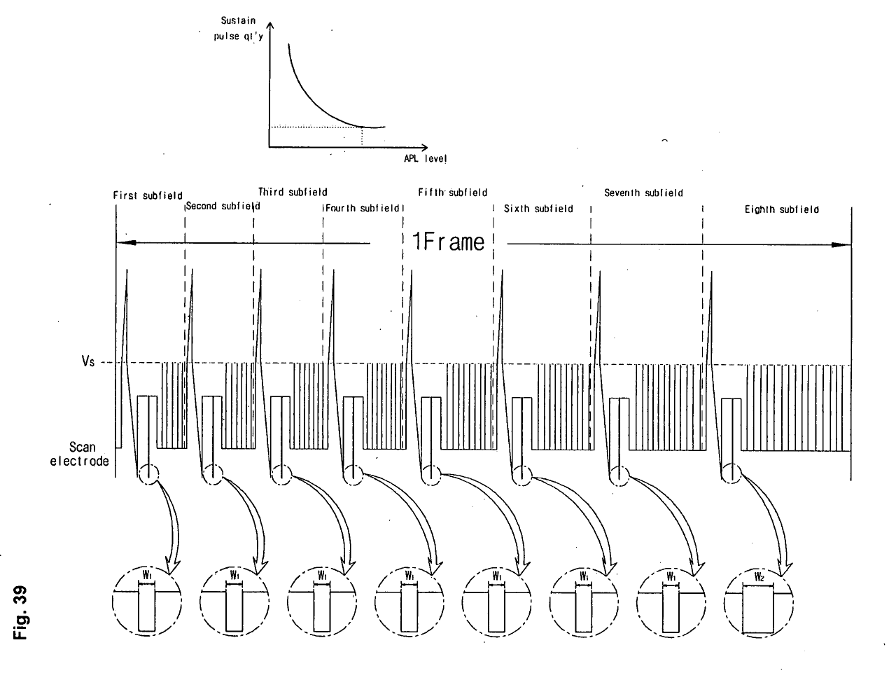

Only the cases in which the APL is low have been described above. The case in which the APL is high will be described with reference to FIG. 39.

FIG. 39 illustrates an example of the case in which the APL is high according to the fifth embodiment of the method of driving the plasma display apparatus for applying the scan pulses according to the present invention.

As illustrated in FIG. 39, according to the fifth embodiment of the method of driving the plasma display apparatus for applying the scan pulses according to the present invention, the widths of the scan pulses applied to the scan electrodes are controlled in one or more sub-fields of one frame in accordance with the APL. When the APL is high, the widths of the scan pulses applied to the scan electrodes in the high gray level sub-fields that have higher brightness weight values to realize high gray levels in the address periods are wider than the widths of the scan pulses applied to the scan electrodes in the remaining sub-fields.

For example, when the APL is high as described above, that is, when the area in which an image is displayed on the screen of the PDP is large (when the number of sustain pulses applied to one discharge cell per a unit gray level is low), the width W2 of the scan pulse applied to the scan electrodes in the sub-field that has a higher brightness weight value, in one frame, for example, the width W2 of the scan pulse in the eighth sub-field is wider than the width W1 of the scan pulses applied to the scan electrodes in the remaining sub-fields.

For example, as illustrated in FIG. 39, when one frame comprises eight sub-fields, the width W2 of the scan pulse applied to the scan electrodes in the eighth sub-field among the sub-fields is wider than the width W1 of the scan pulses applied to the scan electrodes in the remaining sub-fields, that is, the first to seventh sub-fields.

As described above, the reason why the width of the scan pulses in high gray level sub-fields that have higher brightness weight values is wider than the width of the scan pulses in the remaining gray level sub-fields in one frame where the APL is higher is because the area in which the image is displayed on the screen of the PDP is higher when the APL is higher so that the high gray level sub-fields that have higher brightness weight values to realize high gray levels are more frequently selected than the low gray level sub-fields. Therefore, the width of the scan pulses of the high gray level sub-fields that are more frequently selected when the APL is high increases so that the discharge of the PDP stabilizes.

In one frame comprising the sub-fields that are selected with different frequencies in accordance with the difference in the APL, the width of the scan pulses is increased in the sub-fields that are more frequently selected and the width of the scan pulses decreases in the sub-fields that are less frequently selected to stabilize the discharge of the PDP and to prevent the brightness of the PDP from decreasing due to the reduction in the number of sustain pulses, which is caused by an increase in the length of the unnecessary address period.

The widths of the scan pulses applied to the scan electrodes in the sub-fields of one frame are preferably the same.

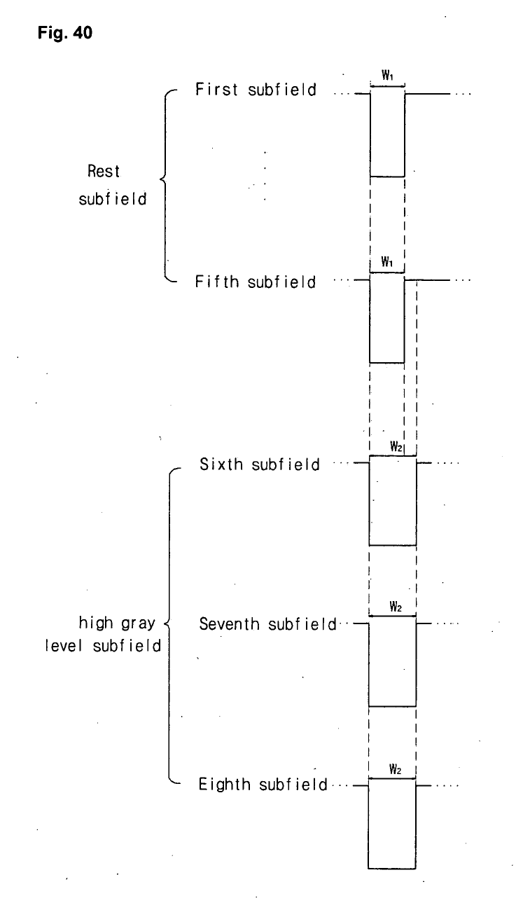

In FIG. 39, the number of high gray level sub-fields where the width of the scan pulses is wider than the width of the scan pulses in the remaining sub-fields in one frame where the APL is higher is one. However, a plurality of high gray level sub-fields may be comprised in one frame. Such a method of driving the plasma display apparatus will be described with reference to FIG. 40.

FIG. 40 illustrates an example in which the widths of the scan pulses are controlled in accordance with the APL in a plurality of sub-fields in one frame. As illustrated in FIG. 40, the width of the scan pulses applied to the scan electrodes in the sixth, seventh and eighth sub-fields in one frame is wider than the width of the scan pulses of the remaining sub-fields, that is, the first, second, third, fourth and fifth sub-fields. In FIG. 40, the APL is higher as illustrated in FIG. 39. As described above, the width of the scan pulses in the high gray level sub-fields that are more frequently selected when the APL is higher, that is, the sixth, seventh and eighth sub-fields is made wider than the width of the scan pulses in the remaining sub-fields.

The high gray level sub-field may be determined based on the number of sustain pulses. For example, the high gray level sub-field preferably comprises a number of sustain pulses that is equal to or less than 20% of the total number of sustain pulses supplied in one frame. For example, when the total number of sustain pulses comprised in one frame is 2,000, the sub-field comprising 400 or more sustain pulses is determined as the high gray level sub-field. When such a rule is applied to FIG. 40, the sixth, seventh and eighth sub-fields of FIG. 40 are the sub-fields each having 400 or more sustain pulses.

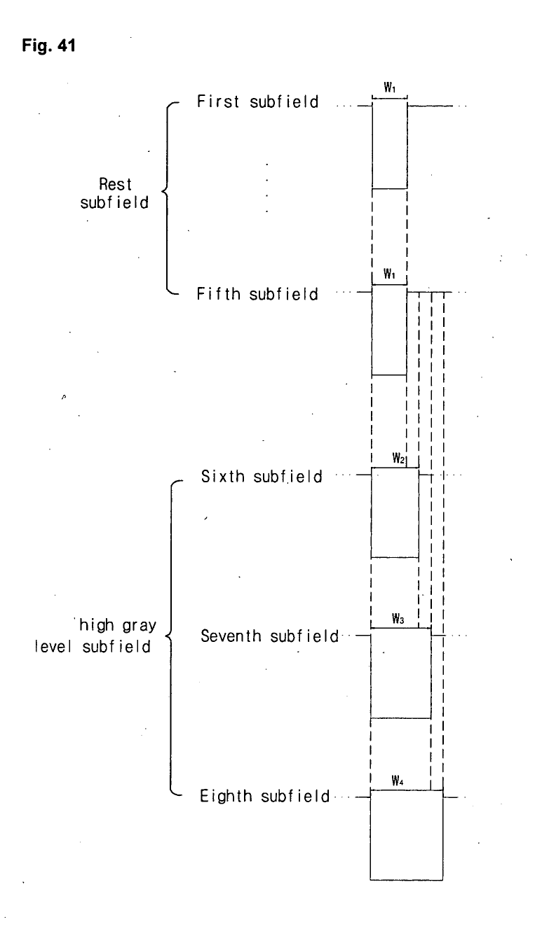

In the driving waveform of FIG. 40, the widths of the scan pulses applied to the scan electrodes in the address periods of the plurality of sub-fields determined as the high gray level sub-fields are the same. However, unlike the above, the widths of the scan pulses applied to the scan electrodes in the address periods of the plurality of sub-fields determined as the high gray level sub-fields may be different from each other, which will be described with reference to FIG. 41.

FIG. 41 illustrates another example in which the widths of the scan pulses are controlled in accordance with the APL in the plurality of sub-fields in one frame.

As illustrated in FIG. 41, the widths of the scan pulses applied to the scan electrodes in the sixth, seventh and eighth sub-fields in one frame are wider than the widths of the scan pulses of the first, second, third, fourth and fifth sub-fields. Here, unlike the illustration n FIG. 40, the width of the scan pulse of the sixth sub-field, the width of the scan pulse of the seventh sub-field, and the width of the scan pulse of the eighth sub-field are different from each other. Here, the sixth, seventh and eighth sub-fields in which the widths of the scan pulses that are different from each other are wider than the widths of the remaining sub-fields, that is, the first, second, third, fourth and fifth sub-fields are the high gray level sub-fields.

In the sixth, seventh and eighth sub-fields that are the high gray level sub-fields in which the widths of the scan pulses are wider, the width W4 of the scan pulse of the eighth sub-field having the highest gray level value is widest, the width W3 of the scan pulse of the seventh sub-field is second widest, and the width W2 of the scan pulse of the sixth sub-field is narrowest. The width W1 of the scan pulses of the remaining sub-fields, that is, the first, second, third, fourth, and fifth sub-fields is narrower than the widths W2, W3 and W4.

In FIG. 41, the widths of the scan pulses of the plurality of the high gray level sub-fields are different from each other. However, the predetermined number of high gray level sub-fields are selected from the plurality of high gray level sub-fields so that the width of the scan pulses in the selected high gray level sub-fields may be different from the widths of the scan pulses in the remaining high gray level sub-fields. For example, in FIG. 41, in the high gray level sub-fields, the width of the scan pulse of the eighth sub-field may be set as W3 and the width of the scan pulses of the remaining high gray level sub-fields, that is, the sixth and seventh sub-fields may be set as W2.

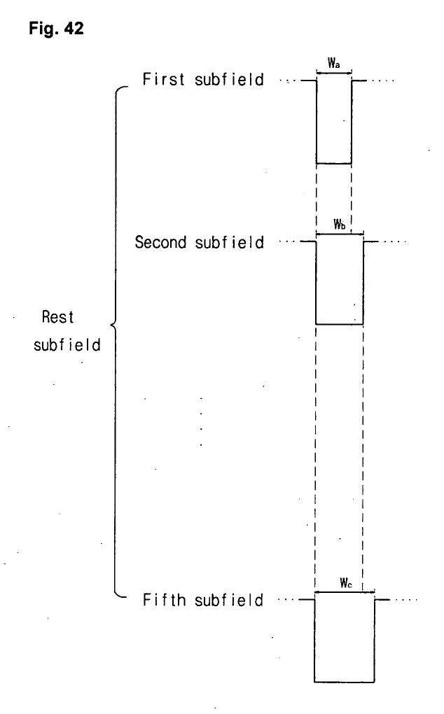

According to the fifth embodiment of the method of driving the plasma display apparatus according to the present invention, the widths of the scan pulses in the remaining sub-fields excluding the high gray level sub-fields among the sub-fields of one frame are the same and are narrower than the widths of the scan pulses in the high gray level sub-fields. However, in the remaining sub-fields excluding the high gray level sub-fields, one or more sub-fields may also have scan pulses of different widths, which will be described with reference to FIG. 42.

FIG. 42 illustrates the widths of the scan pulses in the remaining sub-fields excluding the high gray level sub-fields.

For example, as illustrated in FIG. 42, in the remaining sub-fields excluding the high gray level sub-fields, the width Wa of the scan pulse of the first sub-field having the lowest gray level value is narrowest, the width Wb of the scan pulse of the second sub-field is wider than Wa, and the width Wc of the scan pulse of the fifth sub-field is wider than Wa or Wb. The width Wa, Wb or Wc of the scan pulse is narrower than W2, W3, or W4 in FIG. 41.

As illustrated in FIGS. 39, 40, 41 and 42, the difference in width between the scan pulses of different widths in one frame may be the same or may vary. Since the case in which difference in width between the scan pulses of different widths in one frame is the same was described with reference to FIG. 37, a detailed description thereof will be omitted.

Also, since the case in which the difference in width between the two scan pulses of different widths varies was described with reference to FIG. 38, detailed description thereof will be omitted.

As described above, the scan pulses of wider widths are applied in the low gray level sub-fields when the APL is low and are applied in the high gray level sub-fields when the APL is high so that it is possible to prevent the length of the address period from increasing and to stabilize the discharge of the PDP.

The invention being thus described may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus comprising:
a plasma display panel comprising scan electrodes;
a driver driving the scan electrodes; and
a reset pulse controller controlling the driver to control the magnitudes of the reset pulses applied to the scan electrodes in the reset periods of at least one sub-field among the sub-fields of one frame in accordance with gray level values.

2. The plasma display apparatus as claimed in claim 1,
wherein the magnitudes of the reset pulses have three or more different voltage values, and
wherein the reset pulse controller increases the magnitudes of the reset pulses according as the gray level values of the sub-fields decreases.

3. The plasma display apparatus as claimed in claim 1, wherein the reset pulse controller sets the magnitude of at least one of the reset pulses to be more than twice a sustain voltage.

4. The plasma display apparatus as claimed in claim 3, wherein the magnitudes of the reset pulses are more than twice the sustain voltage in the sub-fields from the sub-field having the lowest number of sustain pulses to the sub-field that comes fourth in the order where the sub-field in which the number of sustain pulses supplied in a sustain period is lowest comes first among the sub-fields of the frame.

5. The plasma display apparatus as claimed in claim 3, wherein the magnitudes of the reset pulses are more than twice the sustain voltage in the sub-fields in which a number of sustain pulses is equal to or less than ½ of the total number of sustain pulses of the sub-field in which the highest number of sustain pulses are supplied in a sustain period are supplied among the sub-fields of the frame.

6. The plasma display apparatus as claimed in claim 3, wherein the magnitudes of the reset pulses are more than twice the sustain voltage in the sub-fields in which a number of sustain pulses is equal to or less than 20% of the total number of sustain pulses of one frame are supplied.

7. The plasma display apparatus as claimed in claim 1, wherein the reset pulse controller sets the magnitude of at least one of the reset pulses to be more than the sustain voltage and less than twice the sustain voltage.

8. The plasma display apparatus as claimed in claim 7, wherein the magnitudes of the reset pulses are more than the sustain voltage and less than twice the sustain voltage in the sub-fields from the sub-field having the highest number of sustain pulses to the sub-field that comes fourth in the order where the sub-field in which the number of sustain pulses supplied in a sustain period is highest comes first among the sub-fields of the frame.

9. The plasma display apparatus as claimed in claim 7, wherein the magnitudes of the reset pulses are more than the sustain voltage and less than twice the sustain voltage in the sub-fields in which a number of sustain pulses is equal to or more than ½ of the total number of sustain pulses of the sub-field in which the highest number of sustain pulses are supplied in a sustain period are supplied among the sub-fields of the frame.

10. The plasma display apparatus as claimed in claim 7, wherein the magnitudes of the reset pulses are more than the sustain voltage and less than twice the sustain voltage in the sub-fields in which a number of sustain pulses is equal to or more than 20% of the total number of sustain pulses of one frame are supplied.

11. The plasma display apparatus as claimed in claim 1, wherein the reset pulse controller makes at least one of the reset pulses fall with a slope after maintaining a positive voltage of a predetermined magnitude.

12. The plasma display apparatus as claimed in claim 11, wherein the magnitude of the positive voltage is equal to the magnitude of the sustain voltage.

13. The plasma display apparatus as claimed in claim 1, wherein the reset pulse controller irregularly arranges the sub-fields comprised in the frame in the order of the magnitudes of the gray level values.

14. An apparatus for driving a plasma display panel comprising scan electrodes, the apparatus comprising:
a driver driving the scan electrodes; and
a reset pulse controller controlling the driver to control the magnitudes of the reset pulses applied to the scan electrodes in the reset periods of at least one sub-fields among the sub-fields of one frame in accordance with gray level values.

15. A plasma display panel comprising scan electrodes, wherein the magnitudes of the reset pulses applied to the scan electrodes in the reset periods of at least one sub-fields among the sub-fields of one frame are controlled in accordance with gray level values.

16. A plasma display apparatus comprising:
a plurality of scan electrodes; and
controller controlling the magnitudes of the reset pulses applied to the scan electrodes in the reset periods of at least one sub-fields among the sub-fields of one frame in accordance with gray level values.

17. A plasma display apparatus comprising a plurality of scan electrodes formed in a top surface panel and a driver applying driving pulses to the scan electrodes, wherein the driver controls the magnitudes of the reset pulses applied to the scan electrodes in the reset periods of at least one sub-fields among the sub-fields of one frame in accordance with gray level values.

18. A method of driving a plasma display apparatus comprising scan electrodes, wherein the magnitudes of the reset pulses applied to the scan electrodes in the reset periods of at least one sub-fields among the sub-fields of one frame are controlled in accordance with gray level values.

19. A plasma display apparatus comprising:
a plasma display panel comprising scan electrodes;
a driver driving the scan electrodes; and
a reset pulse controller controlling the driver to set the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

20. The plasma display apparatus as claimed in claim 19, wherein the reset pulse controller sets the magnitudes of the reset pulses applied to the scan electrodes in the reset periods of the low gray level sub-fields to be more than twice the sustain voltage.

21. The plasma display apparatus as claimed in claim 19, wherein the low gray level sub-fields are the sub-fields from the sub-field having the lowest number of sustain pulses to the sub-field that comes fourth in the order where the sub-field in which the number of sustain pulses supplied in a sustain period is lowest comes first among the sub-fields of the frame.

22. The plasma display apparatus as claimed in claim 19, wherein the low gray level sub-fields are the sub-fields in which a number of sustain pulses is equal to or less than ½ of the total number of sustain pulses of the sub-field in which the highest number of sustain pulses are supplied in a sustain period are supplied among the sub-fields of the frame.

23. The plasma display apparatus as claimed in claim 19, wherein the low gray level sub-fields are the sub-fields in which a number of sustain pulses is equal to or less than 20% of the total number of sustain pulses of one frame are supplied.

24. The plasma display apparatus as claimed in claim 19, wherein the reset pulse controller irregularly arranges the sub-fields comprised in the frame in the order of the magnitudes of gray level values.

25. The plasma display apparatus as claimed in claim 19, wherein the reset pulse controller sets the reset pulses applied to the scan electrodes in the reset periods of at least-one sub-fields among the sub-fields comprised in the frame to fall with a slope after maintaining a positive voltage of a predetermined magnitude.

26. An apparatus for driving a plasma display panel comprising scan electrodes, the apparatus comprising:
a driver driving the scan electrodes; and
a reset pulse controller controlling the driver to set the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

27. A plasma display panel comprising scan electrodes, wherein the magnitudes of the reset pulses applied to the scan electrodes in the reset periods of the low gray level sub-fields among the sub-fields of one frame are more than the magnitudes of the reset pulses applied to the scan electrodes in the reset periods of the remaining sub-fields.

28. A plasma display apparatus comprising:
a plurality of scan electrodes; and
controller setting the magnitudes of the reset pulses applied to the scan electrodes in the reset periods of the low gray level sub-fields among the sub-fields of one frame to be more than the magnitudes of the reset pulses applied to the scan electrodes in the reset periods of the remaining sub-fields.

29. A plasma display apparatus comprising a plurality of scan electrodes formed in a top surface panel and a driver applying driving pulses to the scan electrodes, wherein the driver sets the magnitudes of the reset pulses applied to the scan electrodes in the reset periods of low gray level sub-fields among the sub-fields of one frame to be more than the magnitudes of the reset pulses applied to the scan electrodes in the reset periods of the remaining sub-fields.

30. A method of driving a plasma display apparatus comprising scan electrodes, wherein the magnitudes of the reset pulses applied to the scan electrodes in the reset periods of low gray level sub-fields among the sub-fields of one frame are more than the magnitudes of the reset pulses applied to the scan electrodes in the reset periods of the remaining sub-fields.

31. A plasma display apparatus comprising:
a plasma display panel comprising scan electrodes;
a driver driving the scan electrodes; and
a reset pulse controller controlling the driver to set the magnitudes of the reset pulses applied to the scan electrodes in the reset periods of the high gray level sub-fields among the sub-fields of one frame to be less than the magnitudes of the reset pulses applied to the scan electrodes in the reset periods of the remaining sub-fields.

32. The plasma display apparatus as claimed in claim 31, wherein the reset pulse controller sets the magnitudes of the reset pulses applied to the scan electrodes in the reset periods of the high gray level sub-fields to be more than the sustain voltage and less than twice the sustain voltage.

33. The plasma display apparatus as claimed in claim 31, wherein the reset pulse controller makes the reset pulses applied to the scan electrodes in the reset periods of at least one sub-fields among the sub-fields comprised in the frame fall with a slope after maintaining a positive voltage of a predetermined magnitude.

34. The plasma display apparatus as claimed in claim 33, the sub-fields in which the reset pulses applied to the scan electrodes in the reset periods fall with a slope after maintaining a positive voltage of a predetermined magnitude are the high gray level sub-fields.

35. The plasma display apparatus as claimed in claim 31, wherein the high gray level sub-fields are the sub-fields from the sub-field having the highest number of sustain pulses to the sub-field that comes fourth in the order where the sub-field in which the number of sustain pulses supplied in a sustain period is highest comes first among the sub-fields of the frame.

36. The plasma display apparatus as claimed in claim 31, wherein the high gray level sub-fields are the sub-fields in which a number of sustain pulses is equal to or more than ½ of the total number of sustain pulses of the sub-field in which the highest-number of sustain pulses are supplied in a sustain period are supplied among the sub-fields of the frame.

37. The plasma display apparatus as claimed in claim 31, wherein the high gray level sub-fields are the sub-fields in which a number of sustain pulses is equal to or more than 20% of the total number of sustain pulses of one frame are supplied.

38. The plasma display apparatus as claimed in claim 31, wherein the reset pulse controller irregularly arranges the sub-fields comprised in the frame in the order of the magnitudes of the gray level values.

39. An apparatus for driving a plasma display panel comprising scan electrodes, the apparatus comprising:
a driver driving the scan electrodes; and
a reset pulse controller controlling the driver to set the magnitudes of the reset pulses applied to the scan electrodes in the reset periods of high gray level sub-fields among the sub-fields of one frame to be less than the magnitudes of the reset pulses applied to the scan electrodes in the reset periods of the remaining sub-fields.

40. A plasma display panel comprising scan electrodes, wherein the magnitudes of the reset pulses applied to the scan electrodes in the reset periods of the high gray level sub-fields among the sub-fields of one frame are less than the magnitudes of the reset pulses applied to the scan electrodes in the reset periods of the remaining sub-fields.

41. A plasma display apparatus comprising:
a plurality of scan electrodes; and
controller setting the magnitudes of the reset pulses applied to the scan electrodes in the reset periods of high gray level sub-fields among the sub-fields of one frame to be less than the magnitudes of the reset pulses applied to the scan electrodes in the reset periods of the remaining sub-fields.

42. A plasma display apparatus comprising a plurality of scan electrodes formed in a top surface panel and a driver applying driving pulses to the scan electrodes, wherein the driver sets the magnitudes of the reset pulses applied to the scan electrodes in the reset periods of high gray level sub-fields among the sub-fields of one frame to be less than the magnitudes of the reset pulses applied to the scan electrodes in -the reset periods of the remaining sub-fields.

43. A method of driving a plasma display apparatus comprising scan electrodes, wherein the magnitudes of the reset pulses applied to the scan electrodes in the reset periods of high gray level sub-fields among the sub-fields of one frame are less than the magnitudes of the reset pulses applied to the scan electrodes in the reset periods of the remaining sub-fields.

44. A plasma display apparatus comprising:
a plasma display panel comprising scan electrodes;
a driver driving the scan electrodes; and
a scan pulse controller controlling the driver to set the width of the scan pulses applied to one or more scan electrode group among a plurality of scan electrode groups comprising the one or more scan electrodes in one or more sub-fields of one frame in the order of scanning to be different from the width of the scan pulses applied to the remaining scan electrode groups.

45. The plasma display apparatus as claimed in claim 44, wherein the scan pulse controller makes one or more scan electrodes group among the plurality of scan electrode groups comprise a plurality of scan electrodes and makes the plurality of scan electrodes comprised in the scan electrode group continuously scanned.

46. The plasma display apparatus as claimed in claim 44,
wherein the plurality of scan electrode groups comprise a first scan electrode group and a second electrode group that is scanned later than the first scan electrode group, and
wherein the width of the scan pulses applied to the first scan electrode group is narrower than the width of the scan pulses applied to the second electrode group.

47. The plasma display apparatus as claimed in claim 44, wherein the scan pulse controller sets the number of scan electrodes no less than 2 and no more than the total number of scan electrodes.

48. The plasma display apparatus as claimed in claim 44, wherein the scan pulse controller ensures that each of the scan electrode groups comprise the same number of scan electrodes.

49. The plasma display apparatus as claimed in claim 44, wherein the scan pulse controller ensures that one or more of the scan electrode groups comprise a number of scan electrodes that is different from the number of scan electrodes of the remaining scan electrode groups.

50. The plasma display apparatus as claimed in claim 44, wherein the scan pulse controller applies scan pulses of the same width to all of the scan electrodes comprised in the same scan electrode group.

51. The plasma display apparatus as claimed in claim 44, wherein the scan pulse controller sets a difference in width between any two scan pulses that are used for scanning of any two continuous scan electrode groups to be the same as the difference in width between other two scan pulses that are used for scanning of other two continuous scan electrode groups.

52. The plasma display apparatus as claimed in claim 44, wherein the scan pulse controller sets a difference in width between any two scan pulses that are used for scanning of any two continuous scan electrode groups to be different from the difference in width between other two scan pulses that are used for scanning of other two continuous scan electrode groups.

53. An apparatus for driving a plasma display panel comprising scan electrodes, the apparatus comprising:
a driver driving the scan electrodes; and
a scan pulse controller controlling the driver to set the width of the scan pulses applied to one or more scan electrode group among a plurality of scan electrode groups comprising the one or more scan electrodes in one or more sub-fields of one frame in the order of scanning to be different from the width of the scan pulses applied to the remaining scan electrode groups.

54. A plasma display panel comprising scan electrodes, wherein the width of the scan pulses applied two one or more scan electrode group among a plurality of scan electrode groups comprising the one or more scan electrodes in one or more sub-fields of one frame in the order of scanning is different from the width of the scan pulses applied to the remaining scan electrode groups.

55. A method of driving a plasma display apparatus comprising scan electrodes, wherein the width of the scan pulses applied to one or more scan electrode group among a plurality of scan electrode groups comprising the one or more scan electrodes in one or more sub-fields of one frame in the order of scanning is different from the width of the scan pulses applied to the remaining scan electrode groups.

56. A plasma display apparatus comprising:
a plasma display panel comprising scan electrodes;
a driver driving the scan electrodes; and
a scan pulse controller controlling the driver to control the widths of the scan electrodes applied to the scan electrodes in one or more sub-fields of one frame in accordance with an average picture level (APL).

57. The plasma display apparatus as claimed in claim 56, wherein the scan pulse controller sets the widths of the scan pulses applied to the scan electrodes in the same sub-field to be the same.

58. The plasma display apparatus as claimed in claim 56, wherein the scan pulse controller sets the widths of the scan pulses of low gray level sub-fields among the sub-fields to increase as the APL decreases.

59. The plasma display apparatus as claimed in claim 58, wherein the scan pulse controller makes the widths of the scan pulses of the remaining sub-fields excluding the low gray level sub-fields to decrease as the APL decreases.

60. The plasma display apparatus as claimed in claim 58, wherein the scan pulse controller sets the low gray level sub-fields to be plural and sets the widths of the scan pulses of the plurality of low gray level sub-fields to be the same.

61. The plasma display apparatus as claimed in claim 58, wherein the scan pulse controller sets the low gray level sub-fields to be plural and sets the width of the scan pulses of one or more of the plurality of low gray level sub-fields to be different from the width of the scan pulses of the remaining low gray level sub-fields.

62. The plasma display apparatus as claimed in claim 58, wherein the low gray level sub-fields are the sub-fields having a number of sustain pulses that is equal to or less than 20% of the number of sustain pulses of the sub-field having the highest number of sustain pulses in one frame.

63. The plasma display apparatus as claimed in claim 56, wherein the scan pulse controller sets the widths of the scan pulses of high gray level sub-fields among the sub-fields to increase according as the APL of the frame increases.

64. The plasma display apparatus as claimed in claim 63, wherein the widths of the scan pulses of the remaining sub-fields excluding the high gray level sub-fields decreases.

65. The plasma display apparatus as claimed in claim 63, wherein the scan pulse controller sets the high gray level sub-fields to be plural and sets the widths of the scan pulses of the plurality of high gray level sub-fields to be the same.

66. The plasma display apparatus as claimed in claim 63, wherein the scan pulse controller sets the high gray level sub-fields to be plural and sets the width of the scan pulses of one or more of the plurality of high gray level sub-fields to be different from the width of the scan pulses of the remaining high gray level sub-fields.

67. The plasma display apparatus as claimed in claim 63, wherein the high gray level sub-fields are the sub-fields having a number of sustain pulses that is equal to or more than 20% of the total number of sustain pulses supplied in one frame.

68. The plasma display apparatus as claimed in claim 56, wherein the scan pulse controller sets the difference in width between the scan pulses of continuous two sub-fields having scan pulses of different widths among the sub-fields of the frame to be the same.

69. The plasma display apparatus as claimed in claim 56, wherein the scan pulse controller sets the difference in width between the scan pulses of continuous two sub-fields having scan pulses of different widths among the sub-fields of the frame to vary.

70. An apparatus for driving a plasma display panel comprising scan electrodes, the apparatus comprising:
a driver driving the scan electrodes; and
a scan pulse controller controlling the driver to control the widths of the scan pulses applied to the scan electrodes in one or more sub-field of one frame in accordance with an APL.

71. A plasma display panel comprising scan electrodes, wherein the widths of the scan pulses applied to the scan electrodes are controlled in one or more sub-field of one frame in accordance with an APL.

72. A method of driving a plasma display apparatus comprising scan electrodes, wherein the widths of the scan pulses applied to the scan electrodes are controlled in one or more sub-field of one frame in accordance with an APL.
